(19) United States
(12) Patent Application Publication
(10) Pub. No.: US 2021/0284410 A1
(43) Pub. Date: Sep. 16, 2021

(54) SUPER-HYDROPHOBIC THERMOPLASTIC FILMS FOR PACKAGING

(71) Applicant: Cryovac, LLC, Charlotte, NC (US)

(72) Inventors: Roberto Forloni, RHO (Ml) (IT); Xin Dong, Charlotte, NC (US)

(21) Appl. No.: 17/265,628

(22) PCT Filed: Aug. 3, 2018
(86) PCT No.: PCT/EP2018/071207

§ 371 Date: Feb. 3, 2021

(51) Int. Cl. B65D 65/42; B65D 75/30; B65D 81/20

(52) U.S. Cl. CPC B65D 65/42; B32B 27/08; B65D 81/2023; B65D 75/30

(57) ABSTRACT

Thermoplastic films for packaging having a super-hydrophobic sealant surface (0), flexible packages made therefrom and their use in packaging products, especially food products are described. These packages are characterized by optimal performances, especially in terms of seal strength, recovery of the packaged product and prevention of drip formation.

The present invention relates to thermoplastic films for packaging having a super-hydrophobic sealant surface, to flexible packages made therefrom and to their use in packaging products, especially food products. These packages are characterized by optimal performances, especially in terms of seal strength, recovery of the packaged product and prevention of drip formation.

### BACKGROUND ART

Packaging of flowable products, in particular of flowable food products, in thermoplastic flexible containers, such as pouches, is well known and appreciated in the market.

Flowable products include for instance low viscosity fluids (e.g., juice and soda), high viscosity products (e.g., tomato paste concentrate, hazelnut spread, peanut butter, condiments and sauces), fluid and solid admixtures (e.g., soups and vegetables in brine), gels, powders and powdered materials.

Pouches may be manufactured by different process, in particular by Vertical form Fill Seal process (VFFS process). In this process, the flowable product is introduced into a formed tubular film previously sealed transversally at its lower end and longitudinally. The pouch is then completed by sealing the upper end of the tubular segment and by severing the pouch from the tubular film above it.

In some cases, the pouches have to withstand drastic thermal and/or chemical and/or physical treatments, such as pasteurization or sterilization, in order to reduce or eliminate bacterial contamination. Mechanical integrity, especially along the seals, is particularly important for a proper product shelf-life.

Usually, the final user opens the pouch and manually squeezes out the flowable product for the intended use without particular problems.

However, certain products are so viscous and sticky that it is difficult to remove them efficiently from the pouch with a good product recovery. This is particularly true for dense or sticky food products such as for instance tomato paste concentrate, hazelnut spread, sauces and condiments or peanut butter.

With this kind of products, the yield of recovery from the pouch may be unsatisfactory with an undesirable waste of product.

Films suitable for packaging of flowable products present in the market usually comprise a polyolefin sealant outer layer that, in the pouch, is in contact with the product.

Typically, small amount of sliding agents (e.g. lower than 1% by weight) are present in the sealant layer to facilitate the film sliding on the packaging equipment but these agents are little effective on product recovery.

It is well known in the packaging field, that the outer surfaces of the films may be treated and/or coated with the aim to modify their properties. In particular, surface treatments that lower the wettability of the film surfaces are known.

However, in the Applicant knowledge, most of the treatments applied to packaging films usually make their surfaces hydrophobic, namely with a wettability corresponding to a water contact angle of at most 130° and not super-hydrophobic i.e. with a contact angle higher than 130° or even of 150°.

The documents EP2397319B1 and EP2857190B1 (Toyo) describe multilayer packaging lid films, characterized by very high contact angles and low adherence to the packaged products, said films having an outer sealant layer coated on the outermost surface with hydrophobic oxide nanoparticles. In a preferred embodiment, the same outer sealant layer further include a particulate filler that forms bumps and indentations in the surface (as illustrated in the present FIG. 1A). According to the description of EP2397319B1, the particulate filler provides for a greater abrasion resistance (par. 36) and maintenance of the non-adhesive properties for a long period because the hydrophobic nanoparticles are entrapped as aggregates, in these indentations (par. 26).

The description (see par. 18 and 21) also states that said films might be used not only as lids—as exemplified and claimed—but, also, in the manufacture of bags and pouches.

However, the Applicant found out that the seal strength achievable with these films comprising particulate filler in the sealant layer—which may be sufficient for use as top lid sealed onto rigid containers—is unsatisfactory for the real manufacture of flexible packages, such as pouches and bags.

In fact, these packages made of rather thin films only, differently from lidded packages comprising thick rigid containers, are flexed in use and subjected to more intense physical stress, especially along the seals.

It would be desirable to provide films with a super-hydrophobic surface and low adherence to the packaged products as those shown in the prior art but endowed with a better seal strength when self-sealed for use in flexible packaging applications.

### SUMMARY OF THE INVENTION

The Applicant faced the problem of providing a super-hydrophobic film as described in EP2397319B1 for packaging viscous sticky products that allows a complete recovery of the packaged products but with an improved sealability for use in flexible packaging applications.

As mentioned above, EP2397319B1 teaches that particulate fillers had to be present in the sealant layer in order to maintain the hydrophobic properties over time. Furthermore, the seal tests shown in Table 1 of this patent, in which the film is sealed as a lid onto the flange of rigid containers, suggest that the particulate has little or no influence on the seal performance of the film. In fact, the values of opening strength and sealing strength of the film Ex. 1-1, without particulate, versus the films of Ex. 1-2 to 1-6, with particulate in the sealant layer are comparable. Contrary to EP2397319B1's teaching, the Applicant has surprisingly found that when particulate fillers were incorporated not into the outer coated sealant layer but, instead, into the layer directly adhered to it (i.e. into the second layer), it was possible not only to improve the sealability but also to maintain the superhydrophobic performance overtime (durability).

In addition, the Applicant has unexpectedly found that the film of the present invention, which incorporates the particulate fillers in the second layer only, can effectively prevent drip loss, when used to package drip-forming products under vacuum, especially meat.

A long-felt need in the field of meat packaging is to minimize drip loss from the packaged product. When fresh meat primals, after slaughtering or cooking, are packed under vacuum and stored, they start releasing a drip, i.e. a liquid exudate, which is a mixture of serum, proteins, water-fat emulsion, broth and water. This is particularly evident for fresh meat such as pork, beef, veal, horsemeat, but also for processed meat, such as cooked ham. The quantity of drip varies upon the thermal history of the meat and its quality. When the package is opened, the drip is a net weight loss for the retailer or food processor, as it cannot be sold by weight. Additionally, the presence of exudates in the package reduces its attractiveness, as it is particularly unpleasant at sight and makes the retailer suspicious about meat processing and freshness. In conclusion, the formation and the presence of purge from packaged meat in the packages is a serious drawback.

Several documents deal with the problem of drip loss.

U.S. Pat. No. 4,183,882 (Grace), for instance, relates to films and pouches for packaging meat and addresses the problem of purge formation due to the presence of unshrunk and unsealed areas in the final package. In order to solve drip formation this document suggests the adoption of a particular composition for the seal layer, namely a particular blend of polyethylenes. The sealant surface of these films is not subjected to any particular treatment.

U.S. Pat. No. 5,407,611 (Viskase) describes films and pouches for packaging and cooking meat and faces the problem of purge formation during cook-in of meat packaged in shrunk pouches. In order to reduce exudation of liquids from the food product during cooking, the packaging films were surface irradiated and corona treated. The combination of a high amount of EVA in the outer layer in contact with the food with those surface treatments improve the adhesion of this film to the product during cooking, thus preventing cook-out of the fluids. This document does not suggest any particular coating of the films.

The reduction of purge formation in the present packages is quite unexpected, considering that U.S. Pat. No. 5,407,611 (col 14, lines 1-5) teaches that a high wettability of the film surface and not a super-hydrophobicity was needed to improve adhesion to the product to minimize drip loss.

Without being bound to any particular theory, a possible explanation of the present results may be that the surface of the film of the invention is so hydrophobic that it effectively repels the purge—which is mainly composed of water—forcing it into the meat. As a result, the appearance of the package was greatly improved as well as the product yield.

Finally, the present films having incorporated the microparticles in a layer not directly in contact with the packaged product, are particularly advantageous in terms of Food Law compliance too.

It is thus a first object of the present invention a super-hydrophobic coated thermoplastic multilayer packaging film comprising:
a thermoplastic mono or multilayer base layer (B),
a thermoplastic heat-sealable layer (A) directly adhered to the base layer (B), and
an inorganic coating layer (C) comprising hydrophobic oxide nanoparticles directly adhered to the surface of the heat-sealable layer (A) not directly adhered to the base layer (B),
   wherein said hydrophobic oxide nanoparticles of layer (C) have an average particle diameter from 3 to 100 nm and are present in amount from 0.01 to 10 g/m² (grammage after drying),
   characterized in that
   the base layer (B) comprises microparticles having an average particle diameter from 0.5 to 100 microns in amount of at least 1% calculated in respect of the total weight of the layer(s) in which the microparticles are incorporated.

A second object of the present invention is a process for the manufacture of the super-hydrophobic coated thermoplastic multilayer packaging film of the first object, which comprises:

i) providing a thermoplastic uncoated film (A)/(B) comprising
a thermoplastic mono or multilayer base layer (B),
an outer thermoplastic heat-sealable layer (A) directly adhered to the base layer (B),
   wherein the base layer (B) comprises microparticles having an average particle diameter from 0.5 to 100 microns in amount of at least 1% calculated in respect of the total weight of the layer(s) in which the microparticles are incorporated,
   ii) coating the surface of the heat-sealable layer (A) not directly adhered to the base layer (B) of the thermoplastic uncoated film (A)/(B) by applying an inorganic coating composition comprising hydrophobic oxide nanoparticles having an average particle diameter from 3 to 100 nm, and
   iii) drying the applied coating thus forming an inorganic coating layer (C) comprising hydrophobic oxide nanoparticles in amount from 0.01 to 10 g/m² (grammage after drying).

A third object of the present invention is an article for packaging made from the film of the first object having at least an opening for introducing a product, wherein the inorganic coating layer (C) of the film is the innermost layer of the article.

A fourth object of the present invention is a hermetic package comprising the film of the first object and a product, in which the film hermetically encloses the product and wherein the surface of the package in contact with the product is the inorganic coating layer (C) of the film.

A fifth object of the present invention is the use of the film of the first object for packaging a product, preferably for packaging highly viscous, sticky or drip-releasing product, wherein the surface of the package in contact with the product is the inorganic coating layer (C) of the film.

### BRIEF DESCRIPTION OF THE DRAWINGS

The accompanying drawings are not necessarily drawn to scale.

FIGS. 1A to 1C are sketches of sections of exemplary films according to the prior art EP2397319B1 (FIG. 1A) and to the invention (FIG. 1B, three layer film and 1C, multilayer film). The dotted lines in FIG. 1C, mean that no layer (four layer film), one or more additional layers (five or more layers film) may be present in the represented multilayer film structure. For the sake of simplicity, in these sketches the possible roughness imparted by the microparticles on the other surface was not represented. The microparticles are not necessarily drawn to scale.

FIGS. 2A to 2C are pictures taken with a confocal microscope (magnification of the objective lens 20×) of the heat-sealable surface of a conventional film (2A, film C1, no microparticles), of a film according to the invention (2B, film Ex. 1, microparticles in layer 2) and of a prior art film as those described in EP2397319B1 (2C, film C4, microparticles in layer 1).

FIGS. 3A-3D are sketches of embodiments of pouches according to the invention. In these figures, the striped areas represent “fin seals” while dotted areas “lap seals”.

FIG. 4 is a block diagram of a process for applying a thin layer coating to a film according to the invention.

FIG. 5A is a picture of a piece of meat vacuum packaged with a conventional film while FIG. 5B is a picture of a piece of meat vacuum packaged with the same film whose food contact surface was treated and coated according to the present invention, after 10 days from packaging.

### DEFINITIONS

As used herein, the term “film” is inclusive of plastic web, regardless of whether it is film or sheet or tubing.

As used herein, the terms “inner layer” and “internal layer” refer to any film layer having both of its principal surfaces directly adhered to another layer of the film.

As used herein, the phrase “outer layer” or “external layer” refers to any film layer having only one of its principal surfaces directly adhered to another layer of the film.

As used herein, the phrases “seal layer”, “sealing layer”, “heat-sealable layer”, and “sealant layer”, refer to an outer layer involved in the sealing of the film to itself, in particular to the same outer seal layer or to the other outer layer of the same film, to another film, and/or to another article which is not a film.

As used herein, the words “tie layer” or “adhesive layer” refer to any inner film layer having the primary purpose of adhering two layers to each other.

As used herein, the phrases “longitudinal direction” and “machine direction”, herein abbreviated “LD” or “MD”, refer to a direction “along the length” of the film, i.e., in the direction of the film as the film is formed during coextrusion.

As used herein, the phrase “transverse direction” or “crosswise direction”, herein abbreviated “TD”, refers to a direction across the film, perpendicular to the machine or longitudinal direction.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is generally fed into a rotating screw of variable pitch, i.e., an extruder, which forces the polymeric material through the die. As used herein, the term “coextrusion” refers to the process of extruding two or more materials through a single die with two or more orifices arranged so that the extrudates merge and weld together into a laminar structure before chilling, i.e., quenching. The term “coextrusion” as used herein also includes “extrusion coating”. As used herein, the term “extrusion coating” refers to processes by which a “coating” of molten polymer(s), comprising one or more layers, is extruded onto a solid “substrate” in order to coat the substrate with the molten polymer coating to bond the substrate and the coating together, thus obtaining a complete film.

As used herein the terms “coextrusion”, “coextruded”, “extrusion coating” and the like are referred to processes and multilayer films which are not obtained by sole lamination, namely by gluing or welding together pre-formed webs.

As used herein, the term “orientation” refers to “solid state orientation” namely to the process of stretching of the cast film carried out at a temperature higher than the Tg (glass transition temperatures) of all the resins making up the layers of the structure and lower than the temperature at which all the layers of the structure are in the molten state. The solid state orientation may be mono-axial, transverse or, preferably, longitudinal, or, preferably, bi-axial.

As used herein, the phrases “orientation ratio” and “stretching ratio” refer to the multiplication product of the extent to which the plastic film material is expanded in the two directions perpendicular to one another, i.e. the machine direction and the transverse direction. Thus, if a film has been oriented to three times its original size in the longitudinal direction (3:1) and three times its original size in the transverse direction (3:1), then the overall film has an orientation ratio of 3×3 or 9:1. As used herein the phrases “heat-shrinkable,” “heat-shrink,” and the like, refer to the tendency of the solid-state oriented film to shrink upon the application of heat, i.e., to contract upon being heated, such that the size of the film decreases while the film is in an unrestrained state.

As used herein said term refers to solid-state oriented films with a free shrink in both the machine and the transverse directions, as measured by ASTM D 2732, of at least 10%, preferably at least 15%, even more preferably of at least 20% at 85° C. As used herein, the term “drip-releasing products” means products releasing liquids, purge, droplets of exudate.

As used herein, the term “film surface properties” relates to the common properties of the surface of plastic films such as surface energy, roughness and wettability.

As used herein, the expressions “highly viscous product”, “product with a high viscosity” and the like, refer to a product having a viscosity generally of at least 1000 mPa*s, measured at about 25° C. according to ASTM D445 method.

As used herein, “vacuum deposition” refers to a process that allows depositing a material molecule-by-molecule or by groups of molecules forming a molecular chain on a solid surface to form a layer of the material. The material to be deposited may be a formulated monomer or oligomer in the form of a liquid or a solid. Upon application of vacuum and heat, the material evaporates and then deposits on the film surface. Upon deposition, the material returns to its original state which may be liquid, solid or even gel, if the material is formulated using both a liquid and a solid. As upon heating under vacuum the liquid or solid materials are converted into a vapor, this “vacuum deposition” process is also referred to as vacuum “vapor deposition” process.

As used herein, the term “rough or roughened surface” refers to a surface of a film having a non-smooth pattern, i.e. a surface presenting micro and/or nano sized irregularities such as, e.g., holes, pillars, spikes, wrinkles, scratches, bumps, indentations etc, wherein such structures are engraved in, or protrude from, the surface.

The contact angle θ made by a droplet of liquid on a surface of a solid substrate is used as a quantitative measure of the wettability of the surface. If the liquid spreads completely across the surface and forms a film, the contact angle θ is 0°. For water, a surface or a coating is usually considered to be hydrophobic if the contact angle is greater than 90°. Surfaces or coatings with water contact angles greater than 130° are also referred to as “super-hydrophobic”.

As used herein, the term “super-hydrophobic” refers to the property of a surface to repel water very effectively. This property is expressed by a water contact angle higher than 130°.

As used herein, the term “super-hydrophobic coating composition” refers to a composition that, when applied onto a surface of a thermoplastic film, can form a super-hydrophobic coating.

As used herein, the term “hydrophobic”, refers to the property of a surface to repel water with a water contact angle from about 90° to about 130°.

The term “hydrophilic”, as used herein, refers to surfaces with water contact angles lower than 90°.

As used herein, the term “super-hydrophobic coating” relates to a coating characterized by a water contact angle higher than 130°, said contact angle being measured according to ASTM D7490-13.

As used herein, the term “hydrophobic coating composition” refers to a hydrophobic coating composition comprising components that have the ability to form a hydrophobic coating upon curing and/or drying.

All percentages are by weight of the total composition unless specifically stated otherwise. All ratios are weight ratios unless otherwise specifically stated.

As used herein, the term “inorganic coating” relates to a coating not including major amount of organic compounds, cross-linked or cured polymers, organic networks and the like. Preferably, an inorganic coating does not comprise organic compounds at all.

As used herein, the term “major amount” or “major proportion” refer to an amount of a component higher than 50% by weight in respect of the total amount of the components of a referred element (e.g. a film, a layer etc.).

As used herein, the term “minor amount” or “minor proportion” refer to an amount of a component lower than 50% by weight in respect of the total amount of the components of a referred element (e.g. a film, a layer etc.).

As used herein, the term “polymer” refers to the product of a polymerization reaction, and is inclusive of homo-polymers, and co-polymers.

As used herein, the term “homo-polymer” is used with reference to a polymer resulting from the polymerization of a single type of monomer, i.e., a polymer consisting essentially of a single type of mer, i.e., repeating unit.

As used herein, the term “co-polymer” refers to polymers formed by the polymerization reaction of at least two different types of monomers. For example, the term “co-polymer” includes the co-polymerization reaction product of ethylene and an alpha-olefin, such as 1-hexene. When used in generic terms the term “co-polymer” is also inclusive of, for example, ter-polymers. The term “co-polymer” is also inclusive of random co-polymers, block co-polymers, and graft co-polymers.

As used herein, the phrase “heterogeneous polymer” or “polymer obtained by heterogeneous catalysis” refers to polymerization reaction products of relatively wide variation in molecular weight and relatively wide variation in composition distribution, i.e., typical polymers prepared, for example, using conventional Ziegler-Natta catalysts, for example, metal halides activated by an organometallic catalyst, i. e., titanium chloride, optionally containing magnesium chloride, complexed to trialkyl aluminum and may be found in patents such as U.S. Pat. No. 4,302,565 to Goeke et al. and U.S. Pat. No. 4,302,566 to Karol, et al. Heterogeneous catalyzed copolymers of ethylene and an-olefin may include linear low-density polyethylene, very low-density polyethylene and ultra low-density polyethylene. Some copolymers of this type are available from, for example, The Dow Chemical Company, of Midland, Mich., U.S.A. and sold under the trademark DOWLEX resins.

As used herein, the phrase “homogeneous polymer” or “polymer obtained by homogeneous catalysis” refers to polymerization reaction products of relatively narrow molecular weight distribution and relatively narrow composition distribution. Homogeneous polymers are structurally different from heterogeneous polymers, in that homogeneous polymers exhibit a relatively even sequencing of co-monomers within a chain, a mirroring of sequence distribution in all chains, and a similarity of length of all chains, i.e., a narrower molecular weight distribution. This term includes those homogeneous polymers prepared using metallocenes, or other single-site type catalysts, as well as those homogenous polymers that are obtained using Ziegler Natta catalysts in homogenous catalysis conditions.

The co-polymerization of ethylene and alpha-olefins under homogeneous catalysis, for example, co-polymerization with metallocene catalysis systems which include constrained geometry catalysts, i.e., monocyclopentadienyl transition-metal complexes is described in U.S. Pat. No. 5,026,798 to Canich. Homogeneous ethylene/alpha-olefin copolymers (E/AO) may include modified or unmodified ethylene/alpha-olefin copolymers having a long-chain branched (8-20 pendant carbons atoms) alpha-olefin comonomer available from The Dow Chemical Company, known as AFFINITY and ATTANE resins, TAFMER linear copolymers obtainable from the Mitsui Petrochemical Corporation of Tokyo, Japan, and modified or unmodified ethylene/-olefin copolymers having a short-chain branched (3-6 pendant carbons atoms)-olefin comonomer known as EXACT resins obtainable from ExxonMobil Chemical Company of Houston, Tex., U.S.A.

As used herein, the term “polyolefin” refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and an non-olefinic co-monomer co-polymerizable with the olefin, such as vinyl monomers, modified polymers thereof, and the like. Specific examples include polyethylene homo-polymer, polypropylene homo-polymer, polybutene homo-polymer, ethylene-alpha-olefin which are copolymers of ethylene with one or more-olefins (alpha-olefins) such as butene-1, hexene-1, octene-1, or the like as a comonomer, and the like, propylene-alpha-olefin co-polymer, butene-alpha-olefin co-polymer, ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymer, ionomer resin, polymethylpentene, etc.

As used herein, the term “Cyclo olefin copolymers (COC)” refers to amorphous, transparent thermoplastics produced by copolymerization of cycloolefins such as norbornene or docyclopentadiene with ethylene using a metallocene catalyst.

As used herein the term “ionomer” refers to the products of polymerization of ethylene with an unsaturated organic acid, and optionally also with an unsaturated organic acid (C1-C4)-alkyl ester, partially neutralized with a mono- or divalent metal ion, such as lithium, sodium, potassium, calcium, magnesium and zinc. Typical unsaturated organic acids are acrylic acid and methacrylic acid which are thermally stable and commercially available. Unsaturated organic acid (C1-C4)-alkyl esters are typically (meth)acrylate esters, e.g. methyl acrylate and isobutyl acrylate. Mixtures of more than one unsaturated organic acid comonomer and/or more than one unsaturated organic acid (C1-C4)-alkyl ester monomer can also be used in the preparation of the ionomer.

As used herein, the phrase “modified polymer”, as well as more specific phrases such as “modified ethylene/vinyl acetate copolymer”, and “modified polyolefin” refer to such polymers having an anhydride functionality, grafted thereon and/or copolymerized therewith and/or blended therewith. Preferably, such modified polymers have the anhydride functionality grafted on or polymerized therewith, as opposed to merely blended therewith. As used herein, the term “modified” refers to a chemical derivative, e.g. one having any form of anhydride functionality, such as anhydride of maleic acid, crotonic acid, citraconic acid, itaconic acid, fumaric acid, etc., whether grafted onto a polymer, copolymerized with a polymer, or blended with one or more polymers, and is also inclusive of derivatives of such functionalities, such as acids, esters, and metal salts derived therefrom.

As used herein, the phrase “anhydride-containing polymer” and “anhydride-modified polymer” refer to one or more of the following: (1) polymers obtained by copolymerizing an anhydride-containing monomer with a second, different monomer, and (2) anhydride grafted copolymers, and (3) a mixture of a polymer and an anhydride-containing compound.

As used herein, the phrase “ethylene-alpha-olefin copolymer” refers to heterogeneous and to homogeneous polymers such as linear low density polyethylene (LLDPE) with a density usually in the range of from about 0.900 g/cc to about 0.930 g/cc, linear medium density polyethylene (LMDPE) with a density usually in the range of from about 0.930 g/cc to about 0.945 g/cc, and very low and ultra low density polyethylene (VLDPE and ULDPE) with a density lower than about 0.915 g/cc, typically in the range 0.868 to 0.915 g/cc, and such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

As used herein, the term “EVA” refers to ethylene and vinyl acetate copolymers. The vinylacetate monomer unit can be represented by the general formula: [CH3COOCH═CH2].

As used herein, the phrase “acrylates or acrylate-based resin” refers to homopolymers, copolymers, including e.g. bipolymers, terpolymers, etc., having an acrylate moiety in at least one of the repeating units forming the backbone of the polymer. In general, acrylate-based resins are also known as polyalkyl acrylates. Acrylate resins or polyalkyl acrylates may be prepared by any method known to those skill in the art. Suitable examples of these resins for use in the present invention include ethylene/methacrylate copolymers (EMA), ethylene/butyl acrylate copolymers (EBA), ethylene/methacrylic Acid (EMAA), ethylene/methyl methacrylate (EMMA), optionally modified with carboxylic or preferably anhydride functionalities, ionomers and the like. Such as LOTRYL 18 MA 002 by Arkema (EMA), Elvaloy AC 3117 by Du Pont (EBA), Nucrel 1202HC by Du Pont (EMAA), Surlyn 1061 by Du Pont (lonomer).

As used herein the term “polyamide” refers to high molecular weight polymers having amide linkages along the molecular chain, and refers more specifically to synthetic polyamides such as nylons. Such term encompasses both homo-polyamides and co-(or ter-) polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions, which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side. Exemplary polymers are polyamide 6, polyamide 6/9, polyamide 6/10, polyamide 6/12, polyamide 11, polyamide 12, polyamide 6/12, polyamide 6/66, polyamide 66/6/10, modifications thereof and blends thereof. Said term also includes crystalline or partially crystalline, aromatic or partially aromatic polyamides.

As used herein, the phrase “amorphous polyamide” refers to polyamides or nylons with an absence of a regular three-dimensional arrangement of molecules or subunits of molecules extending over distances, which are large relative to atomic dimensions. However, regularity of structure exists on a local scale. See, “Amorphous Polymers,” in Encyclopedia of Polymer Science and Engineering, 2nd Ed., pp. 789-842 (J. Wiley & Sons, Inc. 1985). This document has a Library of Congress Catalogue Card Number of 84-19713. In particular, the term “amorphous polyamide” refers to a material recognized by one skilled in the art of differential scanning calorimetry (DSC) as having no measurable melting point (less than 0.5 cal/g) or no heat of fusion as measured by DSC using ASTM 3417-83. Such nylons include those amorphous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

As used herein, the term “polyester” refers to homopolymers or copolymers (also known as “copolyesters”) having an ester linkage between monomer units which may be formed, for example, by condensation polymerization reactions of lactones or by polymerization of dicarboxylic acid(s) and glycol(s). With the term “(co)polyesters” both homo and copolymers are intended.

As used herein, the term “aromatic polyester” refers to homopolymers or copolymers (also known as “copolyesters”) having an ester linkage between one or more aromatic or alkylsubstituted aromatic dicarboxylc acids and one or more glycols. The term “(co)polyesters” refer to both homo- and copolymers.

As used herein, the term “adhered” is inclusive of films which are directly adhered to one another using a heat-seal or other means, as well as films which are adhered to one another using an adhesive which is between the two films.

As used herein, the phrase “directly adhered”, as applied to layers, is defined as adhesion of the subject layer to the object layer, without a tie layer, adhesive, or other layer therebetween.

In contrast, as used herein, the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

As used herein the term “gas-barrier” when referred to a layer, to a resin contained in said layer, or to an overall structure, refers to the property of the layer, resin or structure, to limit to a certain extent passage through itself of gases.

When referred to a layer or to an overall structure, the term “gas-barrier” is used herein to identify layers or structures characterized by an Oxygen Transmission Rate (evaluated at 23° C. and 0% R.H. according to ASTM D-3985) of less than 500 cc/m2·day·atm, preferably lower than 100 cc/m2·day·atm, even more preferably lower than 50 cc/m2·day·atm.

As used herein the term “PVDC” refers to vinylidene chloride homopolymers or copolymers.

A PVDC copolymer, comprises a major amount of vinylidene chloride and a minor amount of one or more comonomers. A major amount is defined as one of more than 50%.

As used herein, the phrase “flexible container” is inclusive of end-seal pouches, side-seal pouches, L-seal pouches, U-seal pouches (also referred to as “pouches”), gusseted pouches, backseamed tubings, and seamless casings.

As used herein, the phrase “an article for packaging in the form of a seamless tubing” relates to a tubing devoid of any seal which is generally made of a multilayer film (co)extruded through a round die, optionally oriented, wherein the coated heat-sealing layer (A) is the innermost layer of the tubing.

As used herein, the term “package” is inclusive of packages made from such articles, i.e. containers or tubings, by placing a product in the article and sealing the article so that the product is substantially surrounded by the film from which the packaging container is made.

As used herein, the term “pouch” refers to a packaging container having an open top, side edges, and a bottom edge. The term “pouch” encompasses lay-flat pouches, pouches, casings (seamless casings and backseamed casings, including lap-sealed casings, fin-sealed casings, and butt-sealed backseamed casings having backseaming tape thereon). Various casing configurations are disclosed in U.S. Pat. No. 6,764,729 and various pouch configurations, including L-seal pouches, backseamed pouches, and U-seal pouches, also referred to as pouches, are disclosed in U.S. Pat. No. 6,790,468.

As used herein the term “average particle diameter” refers to the average diameter measured with a scanning electron microscope (FE-SEM), which can also be used in combination with another electron microscope such as a transmission electron microscope if the resolution of the scanning electron microscope is too low. Specifically, taking the particle diameter when the particles are spherical and the average of the longest dimension and shortest dimension as the diameter when they are non-spherical, the average particle diameter is the average of the diameters of 20 randomly-selected particles observed by scanning electron microscopy or the like.

As used herein the term “microparticles” refers to particle having an average particle diameter from 0.5 to 100 microns.

As used herein the term “nanoparticles” refers to particle having an average particle diameter from 3 to 100 nm.

Unless otherwise stated, all the percentages are percentages by weight.

### DETAILED DESCRIPTION OF THE INVENTION

It is a first object of the present invention a super-hydrophobic coated thermoplastic multilayer packaging film comprising:
a thermoplastic mono or multilayer base layer (B),
a thermoplastic heat-sealable layer (A) directly adhered to the base layer (B), and
an inorganic coating layer (C) comprising hydrophobic oxide nanoparticles directly adhered to the surface of the heat-sealable layer (A) not directly adhered to the base layer (B),
   wherein said hydrophobic oxide nanoparticles of layer (C) have an average particle diameter from 3 to 100 nm and are present in amount from 0.01 to 10 g/m² (grammage after drying),
   characterized in that
   the base layer (B) comprises microparticles having an average particle diameter from 0.5 to 100 microns in amount of at least 1% calculated in respect of the total weight of the layer(s) in which the microparticles are incorporated.

In the following, the coating layer (C) is also named as layer (0), the heat-sealable layer (A) as layer (1) and the layer directly adhered to the heat-sealable layer's non-coated surface as layer (2).

The film of the present invention comprises the sequence of directly adhered layers (C)/(A)/(B).

The film according to the present invention comprises a thermoplastic heat-sealable layer (A).

Preferably, the heat-sealable layer (A) of the present film comprises a major amount of a polymer selected among ethylene-vinyl acetate copolymers (EVA), polyethylenes, homogeneous or heterogeneous, linear ethylene-alpha-olefin copolymers, polypropylene copolymers (PP), ethylene-propylene copolymers (EPC), acrylates, methacrylates, ionomers, polyesters and their blends.

Preferably, the heat—sealable layer (A) comprises more than 60% 70%, 80%, 90%, 95%, by weight with respect to the same layer, more preferably substantially consists, of one or more of said polymers.

EVA is a copolymer formed from ethylene and vinyl acetate monomers wherein the ethylene units are present in a major amount and the vinyl-acetate units are present in a minor amount. The typical amount of vinyl-acetate may range from about 5 to about 20%.

Particularly preferred polymer for the heat-sealable layer (A) are heterogeneous materials as linear low density polyethylene (LLDPE) with a density usually in the range of from about 0.910 g/cc to about 0.930 g/cc, linear medium density polyethylene (LMDPE) with a density usually in the range of from about 0.930 g/cc to about 0.945 g/cc, and very low and ultra low density polyethylene (VLDPE and ULDPE) with a density lower than about 0.915 g/cc; and homogeneous polymers such as metallocene-catalyzed EXACT™ and EXCEED™ homogeneous resins obtainable from Exxon, single-site AFFINITY™ resins obtainable from Dow, QUEO by Borealis, TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

These polymers can be advantageously blended in various percentages to tailor the sealing properties of the films depending on their use in packaging, as well known by those skilled in the art.

In a preferred embodiment, the heat-sealable layer (A) consists of blends of LLDPE and m-PE resins.

In general, the preferred resins for the heat-sealable layer (A) have a seal initiation temperature lower than 110° C., more preferably a seal initiation temperature lower than 105° C., and even more preferably a sealing initiation temperature lower than 100° C.

The heat-sealable layer (A) of the film of the present invention may have a typical thickness from 2 to 30 microns, preferably from 3 to 25 microns, more preferably from 4 to 20 microns.

In the film of the present invention, the heat-sealable layer (A) may comprise microparticles having an average particle diameter higher than 0.5 microns but in amount lower than 1%, preferably lower than 0.5%, calculated in respect of layer (A) weight. More preferably, layer (A) does not comprise any of those microparticles. The heat-sealable layer (A) may include additives commonly used in sealable packaging films such as for instance pigments, lubricants, anti-oxidants, radical scavengers, UV absorbers, thermal stabilizers, anti-blocking agents, surface-active agents, slip aids, optical brighteners, gloss improvers, viscosity modifiers, as appropriate. In case these additives are microparticles having an average particle diameter higher than 0.5 microns, they are present in amount lower than 1% by weight calculated in respect of layer (A) weight.

The polymers used for the heat-sealable layer and the absence of particulate in heat-sealable layer (A) of the present films provide for high seal strengths. This assures that the final package will protect the packaged product from the outside environment, without accidental openings or leakers.

The film according to the present invention comprises a thermoplastic mono or multilayer base layer (B).

In a first embodiment, the base layer (B) consists of a single layer (b) and the corresponding film is a tri-layer film with the sequence (C)/(A)/(b).

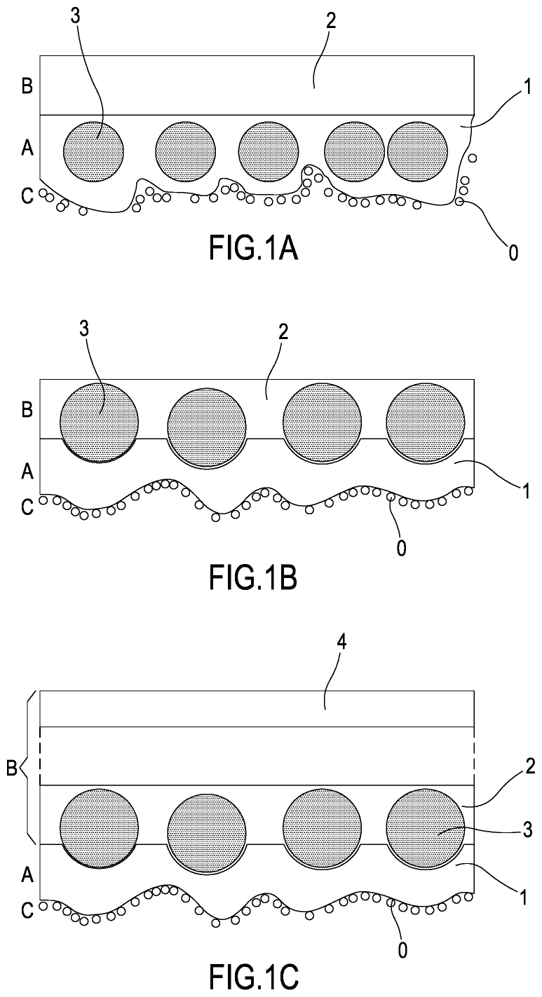

In FIG. 1B, a section of a film according to this embodiment is illustrated. This film comprises the base layer (b) (2) incorporating the microparticles (3), a heat-sealable layer (A) (1) and a coating layer (C) (0) of hydrophobic oxide nanoparticles.

The layer (b) comprises one or more thermoplastic resins commonly used in the manufacture of packaging films.

Preferably, in this first embodiment of the film, the layer (b) comprises a major proportion of, more preferably consists of, one or more thermoplastic resins selected from polyethylenes, polypropylenes, ethylene vinyl acetates (EVAs), ionomers, polyamides, polyesters, optionally blended with adhesive resins, such as anhydride modified polyolefins, in order to improve the adhesion to the heat-sealable layer.

According to this embodiment of the invention, the layer (b) comprises the microparticles (3).

The layer (b) in this first embodiment may have a typical average thickness from 15 to 80 microns, more preferably from 20 to 70 microns, depending on the final packaging use.

The thickness of layer (b) together with the diameter of the microparticles (3) are important to get the desired surface roughness.

The skilled technician can modulate the thickness of layer (b) in order to get a more or less roughening of the surface, adapting the thickness to the diameter of the microparticles or vice versa, selecting microparticles of a diameter tailored onto layer (b) desired thickness.

Optionally, the outer surface of the base layer (b) not adhered to layer (A) may be superficially treated and/or coated in order to modify its surface properties.

This outer surface of the base layer (b) may be coated for instance with acrylic coatings or with the present hydrophobic oxide nanoparticles.

In case in the present film two external coating layers (C) are present, one onto the sealant layer (A) and the other onto the base layer (b), they may be the same or different.

In a second embodiment, the base layer (B) comprises two or more layers of thermoplastic resins.

FIG. 1C shows a sketched section of a film corresponding to this embodiment. This film comprises a multilayer base layer (B) which includes layer (2) incorporating the microparticles (3), other optional layers (dotted-lines) and an outer layer (4), a heat-sealable layer (A) (1) and a coating layer (C) (0) of hydrophobic oxide nanoparticles. In case of a multilayer base layer (B), the layer directly adhered to the heat-sealable layer (A), herein named as layer (2), preferably comprises a major proportion of, preferably consists of, one or more polymers selected among polyolefins and modified polyolefins.

In one embodiment, layer (2) comprises a major proportion of, preferably consists of, one or more polymers selected among Polypropylenes, Ethylene Butyl Acrylate Copolymers (EBAs) and Ethylene Acrylic Acid Copolymers (EAAs).

Preferably, layer (2) is a tie layer (D) or a bulk layer (H) as defined in the following. According to the present embodiment of the invention, layer (2) comprises the microparticles.

Optionally, microparticles may further be present in other internal film layers. In such a case, preferably layer (2) comprises a major proportion of microparticles.

Preferably, only layer (2) comprises microparticles.

Preferably, the microparticles are not incorporated into the barrier layer (F) to avoid damages to its gas barrier properties.

Layer (2) may have a typical average thickness from 2 to 100 microns, preferably from 5 to 50 microns, more preferably from 10 to 40, even more preferably from 10 to 20 microns.

The thickness of layer (2) together with the diameter of the microparticles (3) are important to get the desired surface roughness.

The skilled technician can modulate the thickness of layer (2) in order to get a more or less roughening of the surface, adapting the thickness to the diameter of the microparticles or vice versa, selecting microparticles of a diameter tailored onto layer (2) thickness.

The film of the invention comprises microparticles having an average particle diameter from 0.5 to 100 microns in layer (B).

Preferably, the microparticles have an average particle diameter from 5 to 80 microns, more preferably from 10 to 60 microns, according to laser particle size distribution analysis.

In order to be effective in roughening the film surface, the microparticles preferably have an average particle diameter of at least 20%, preferably at least 30%, more preferably at least 50% greater than the thickness of the layer of the film in which the microparticles are incorporated.

The microparticles may comprise an organic component and/or an inorganic component.

The organic component may be selected, for instance, among acrylic resin, urethane resin, melamine resin, amino resin, epoxy resin, polyethylene resin, pol-ystyrene resin, polypropylene resin, polyester resin, cellulose resin, vinyl chloride resin, polyvinyl alcohol, ethylene-vinylacetate copolymer, ethylene-vinyl alcohol copolymer, ethylene-ethyl acrylate copolymer, polyacrylonitrile or polyamide.

The inorganic component may be selected, for instance, among aluminum, copper, iron, titanium, silver, calcium and other metals or alloys or intermetallic compounds containing these, silicon oxide, aluminum oxide, zirconium oxide, titanium oxide, iron oxide and other oxides, calcium phosphate, calcium stearate and other inorganic acid salts or organic acid salts, glass and aluminum nitride, boron nitride, silicon carbide, silicon nitride and other ceramics.

Preferably, the microparticles are selected among acrylic microparticles, silica microparticles, boron silicate microparticles, calcium phosphate microparticles, calcium stearate microparticles, glass microparticles and charcoal powders. Suitable microparticles are for instance microparticles of acrylates such as Altuglas B100 (average particle size 30 microns) and Altuglas B130 (average particle size of 20 microns) from Arkema, solid glass microparticles such as Spheriglass 3000 (average particle size of 35 microns), hollow glass microparticles such as Sphericel® 60P18 (average particle size of 20 microns) from Potters Industries, Eccospheres® SID230Z (average particle size of 55 microns) from Trelleborg or boron silicate microparticles such as iM30K from 3M (average particle size of 18 microns).

The microparticles may have any form such as spherical, spheroid, indeterminate form, teardrop, flake or the like.

Preferably, the microparticles are solid (i.e. not hollow or porous) microparticles, as they are more resistant to the extrusion conditions and provide a better surface roughness.

The content of the microparticles in the thermoplastic layer(s)—which is layer (b) in case of monolayer base layer (B), layer (2) only or layer (2) together with one or more other layers in case of multilayer base layer (B)—may be varied appropriately according to the types of thermoplastic polymer(s) and microparticles, the desired physical properties and the like.

In general, the content of microparticles is from 1 to 80%, preferably 3 to 50%, more preferably from 15 to 35%, calculated in respect of the total weight of the layer(s) in which the microparticles are incorporated.

The content of microparticles is calculated in respect of either the single layer weight
namely layer (b) in case of a monolayer base layer (B) or layer (2) as previously defined in case of multilayer base layer (B) where the microparticles are contained in layer (2) only- or the total weight of the layers in case of a multilayer base layer (B) containing the microparticles in more than one layer.

The microparticles incorporated in the base layer (B) of the film of the invention, make at least the surface of layer (A) of the film rough, with peaks and indentations. In the present films, the outer surface of the heat-sealable layer (A) is rough due to the incorporation of the microparticles in the base layer (B).

In case the base layer (B) is a single layer (b), the incorporation of the microparticles may render rough both the outer surfaces of the layers (A)/(B).

The multilayer base layer (B) may include further layers.

For instance, the multilayer base layer (B) may include one or more inner tie layers (D) having the main function of improving adhesion between the layers.

The tie layer (D) comprises a major proportion of, preferably consists of, one or more adhesive polymers selected among polyolefins and modified polyolefins.

Specific, not limitative, examples of adhesive resins include ethylene-vinyl acetate copolymers, ethylene-(meth)acrylate copolymers, ethylene-alpha-olefin copolymers, any of the above modified with carboxylic or anhydride functionalities, elastomers, and blends thereof.

The tie layer (D) may comprise at least one styrene-based polymer selected from the group consisting of styrene-ethylene-butylene-styrene copolymer, styrene-butadiene-styrene copolymer, styrene-isoprene-styrene copolymer, styrene-ethylene-butadiene-styrene copolymer, and styrene-(ethylene-propylene rubber)-styrene copolymer.

The tie layer (D) may have a typical thickness from 2 to 15 microns, preferably from 3 to 10 microns.

The multilayer base layer (B) may include an outer abuse layer (E) which, in the flexible container, is the outermost layer.

The polymer(s) for the outer abuse layer (E) is also selected for its heat resistance during the sealing step. In fact, may be advantageous to use for this layer a polymer having a melting point higher than the melting point of the polymer of the heat-sealable layer (A).

The outer abuse layer (E), preferably comprises a major proportion of, preferably consists of, a polymer selected among polyolefins, ethylene-vinyl acetate copolymers, ionomers, (meth)acrylates copolymers, polyamides, polyesters and their blends.

Optionally, the surface of the outer abuse layer (E) not adhered to an inner layer may be superficially treated and/or coated in order to modify its surface properties. In case in the present film two external coating layers (C) are present, one onto the sealant layer (A) and the other onto the outer layer (E), they may be the same or different.

The multilayer base layer (B) may include an inner gas barrier layer (F).

The inner gas barrier layer (F) of the present film preferably comprises a major proportion of, preferably consists of, a polymer selected among polyvinyl alcohol copolymers (PV/A), ethylene/vinyl alcohol copolymers (EVOH), polyvinyl chlorides (PVC), polyvinylidene chloride copolymers (PVDC), polyvinylidene chloride/vinylchloride copolymers (PVDC-VC), polyvinylidene chloride/methyl acrylate copolymers (PVDC/MA), blends of polyvinylidene chloride/vinylchloride copolymers (PVDC/VC) and polyvinylidene chloride/methyl acrylate copolymers (PVDC/MA), blends of PVdC and polycaprolactone (as those described in patent EP2064056 B1, example 1 to 7, particularly useful for respiring food products as certain cheeses), polyester homopolymers and copolymers, polyamide homopolymers and copolymers and their blends.

The inner gas barrier layer (F) of the present films may comprise at least 70%, at least 80%, at least 90%, at least 95% of polyvinylidene chloride, preferably consists of polyvinylidene chloride. With polyvinylidene chloride, homopolymers of vinylidene chloride or its copolymers with other suitable monomers in minor amount are meant. Preferred polymers for the gas barrier layer (F) layer are PVDC copolymers. Especially preferred copolymers are vinylidene chloride-methyl acrylate copolymers, vinylidene chloride-vinyl chloride copolymers, vinylidene chloride-acrylonitrile copolymers and vinylidene chloride-methyl acrylate-vinyl chloride terpolymers. Preferably, the present films comprise only one internal gas barrier layer (F) comprising polyvinylidene chloride.

In another embodiment, the inner barrier layer (F) comprises EVOH, optionally in admixture with polyamides.

In case the film according to the invention comprises an outer layer (E) and an inner gas barrier layer (F), it may be sketched as follows:
(C)/(A)/layer (2) with microparticles/ . . . /(F)/ . . . /(E)

The multilayer base layer (B) may comprise additional inner layers, such as stiff layer(s) (G) or bulk layer(s) (H).

The stiff layer(s) (G) preferably comprise a major proportion of, preferably consists of, a stiff polymer selected among polyamides, polyesters, HDPE, polypropylenes, Cyclic olefin copolymer (COC), polystyrenes and their blends.

Preferably, in case of packaging of hot products or for cook-in applications, the present film may include one or more layer(s) of thermal resistant materials such as for instance aromatic polyesters or polyamides commonly used in ovenable packages (see for instance EP2527142A1 and EP1393897A2 and the thermal resistant materials mentioned therein).

If present, preferably the overall thickness of stiff or thermoresistant stiff layers (G) is higher than 5% and lower than 50%, more preferably higher than 10% and/or lower than 40% with respect to the film total thickness.

The bulk layer(s) (H) preferably comprise a major proportion of, preferably consists of, a polymer selected among EVA, acrylate based resins, ionomers, polyolefins, modified polyolefins and their admixtures.

Preferably, the overall thickness of the one or more bulk layers (H) is lower than 60%, more preferably lower than 40% and/or higher than 10%, more preferably higher than 20% with respect to the total film thickness.

The layers of the present film may contain appropriate amounts of additives typically included in such polymer compositions.

These additives include slip and anti-block agents such as talc, waxes, silica, and the like, antioxidants, stabilizers, plasticizers, fillers, pigments and dyes, cross-linking inhibitors, cross-linking enhancers, UV absorbers, odour absorbers, oxygen scavengers, antistatic agents, anti-fog agents or compositions, and the like additives known to those skilled in the art of packaging films. As explained above, the heat-sealable layer (A) may comprise microparticles having an average particle diameter higher than 0.5 microns in amount lower than 1%, preferably lower than 0.5%, calculated in respect of layer (A) weight, more preferably it does not contain that microparticles at all.

In one embodiment, the film of the invention consists of a heat-sealable layer (A), of a base layer (B), of a first coating layer (C) applied onto the roughened surface of the heat-sealable layer (A) and of a second, same or different, coating layer (C) applied onto the roughened surface of the base layer (B), in a sequence (C)/(A)/(B)/(C).

Preferred non-exhaustive layer sequences for the film of the present invention are the following:

(C)/(A)/(b), (C)/(A)/(D)/(E), (C)/(A)/(D)/(F)/(D)/(E), (C)/(A)/(H)/(D)/(F)/(D)/(H)/(E), (C)/(A)/(D)/(H)/(D)/(F)/(D)/(H)/(D)/(E), (C)/(A)/(H)/(D)/(D)/(F)/(D)/(H)/(E), (C)/(A)/(H)/(D)/(F)/(D)/(G), (C)/(A)/(H)/(D)/(F)/(D)/(H)/(G), (C)/(A)/(H)/(D)/(F)/(D)/(H)/(D)/(G)
wherein layer (A) is the heat-sealable layer, layer (b) is the base layer (B) when monolayer, layer (C) is the super-hydrophobic coating layer, layer (D) is a tie layer, layer (E) is an outer abuse layer, layer (F) is an inner gas barrier layer, layer (G) is a stiff layer, layer (H) is a bulk layer.

The film according to the present invention comprises an inorganic coating layer (C) comprising hydrophobic oxide nanoparticles directly adhered to the surface of the heat-sealable layer (A).

The coating layer (C) of the present film, is an inorganic coating, namely a coating comprising major amount of inorganic elements and not including major amount of organic compounds, oligomers, cross-linked or cured polymers, organic networks and the like. Preferably, the coating layer (C) does not comprise organic compounds, oligomers, cross-linked or cured polymers or organic networks.

The hydrophobic oxide nanoparticles when coated onto the heat-sealable layer (A) form a porous coating layer (C) having a three-dimensional network structure.

Preferably, the coating layer (C) has a thickness from 0.1 to 5.0 microns, more preferably from 0.2 to 4 microns, more preferably from 1.0 to 2.5 microns.

The hydrophobic oxide nanoparticles of the inorganic coating layer (C) have an average particle diameter from 3 to 100 nm, preferably from 5 to 50 nm, more preferably from 5 to 20 nm.

The average particle diameter can be measured with a scanning electron microscope (FE-SEM), possibly in combination with an electron microscope such as a transmission electron microscope.

The specific surface area (BET method) of the hydrophobic oxide nanoparticles is not particularly limited, but is normally 50 to 300 m²/g, preferably 100 to 300 m²/g, measured according to ISO9277.

The amount of the hydrophobic oxide nanoparticles deposited onto the heat-sealable layer (A) (grammage after drying) is from 0.01 to 10 g/m², preferably from 0.1 to 2.0 g/m², more preferably from 0.2 to 1.5 g/m².

The hydrophobic oxide nanoparticles are not especially limited as long as they have hydrophobic properties. Accordingly, they may be particles made hydrophobic by suitable surface treatments, such as reactions with silane coupling agents.

Examples of suitable oxides are silica (silicon dioxide), alumina, magnesia, titania or the like, and their admixtures.

Examples of silica include the products Aerosil R972, Aerosil R972V, Aerosil R972CF, Aerosil R974, Aerosil RX200 and Aerosil RY200 (Japan Aerosil) and Aerosil R202, Aerosil R805, Aerosil R812 and Aerosil R812S (Evonik Degussa). Examples of titania include the product Aeroxide TiO2 T805 (Evonik Degussa) and the like.

Examples of alumina include nanoparticles such as Aeroxide Alu C (Evonik Degussa) made hydrophobic by surface treatment with a silane coupling agent.

Preferably, the hydrophobic oxide is silica, as such or as silica precursor, for instance tetraethyl orthosilicate (TEOS) and the like.

Preferably, highly hydrophobic silica particles having surface trimethylsilyl groups are used.

The coating layer (C) may additionally comprise other inorganic elements such as zinc and/or magnesium.

The coating layer (C) confers to the film surface super-hydrophobic properties.

The surface of the present film coated with the coating layer (C) is characterized by a water contact angle higher than 130°, preferably higher than 140°, more preferably higher than 150°, even more preferably higher than 160° measured according to ASTM D7490-13.

The super-hydrophobic coating of the present films provides for very good gliding properties, which are particularly advantageous for full recovering highly viscous or sticky products from their flexible packages. Surprisingly, drip releasing products, such as fresh meat, form less purge when vacuum packaged in the present films.

Preferably, the coating layer (C) is a single layer coating but a multilayer coating is also possible.

The film of the present invention is characterized by a total thickness from 7 to 250 microns, preferably from 10 to 200 microns.

The film of the present invention is characterized by a total thickness lower than 250 microns, preferably lower than 200 microns or than 150 microns.

The film of the invention may be oriented, optionally biaxially oriented, and may be heat-shrinkable.

Preferably, for packaging dripping product, the film of the invention is oriented and heat-shrinkable.

For shrinkable bags for packaging dripping products, the film of the invention may be characterized by a % free shrink in each one of LD and TD direction of at least 10%, preferably at least 15%, even more preferably of at least 20% at 85° C. and a total free shrink at 85° C. of at least 45%, preferably at least 55%, even more preferably at least 60% (according to ASTM D2732).

Preferably, for packaging highly viscous or sticky products, the film of the invention is not oriented and not heat-shrinkable.

A second object of the present invention is a process for the manufacture of the super-hydrophobic coated thermoplastic multilayer packaging film of the first object, which comprises:

i) providing a thermoplastic uncoated film (A)/(B) comprising
a thermoplastic mono or multilayer base layer (B),
an outer thermoplastic heat-sealable layer (A) directly adhered to the base layer (B),
   wherein the base layer (B) comprises microparticles having an average particle diameter from 0.5 to 100 microns in amount of at least 1% calculated in respect of the total weight of the layer(s) in which the microparticles are incorporated,
   ii) coating the surface of the heat-sealable layer (A) not directly adhered to the base layer (B) of the thermoplastic uncoated film (A)/(B) by applying an inorganic coating composition comprising hydrophobic oxide nanoparticles having an average particle diameter from 3 to 100 nm, and
   iii) drying the applied coating thus forming an inorganic coating layer (C) comprising hydrophobic oxide nanoparticles in amount from 0.01 to 10 g/m² (grammage after drying). The process for the manufacture of the film of the invention first involves providing an uncoated film (A)/(B) comprising
a thermoplastic mono or multilayer base layer (B), and
an outer thermoplastic heat-sealable layer (A) directly adhered to the base layer (B) (step i).

The heat-sealable layer (A) of the uncoated film (A)/(B) may comprise microparticles having an average particle diameter higher than 0.5 microns but in amount lower than 1%, preferably lower than 0.5%, calculated in respect of layer (A) weight. More preferably, layer (A) does not comprise any of those microparticles.

The thermoplastic uncoated film (A)/(B) may be manufactured according to conventional techniques, such as by coextrusion of all the layers, by coextrusion of some layers followed by extrusion-coating or by lamination of the remaining layers, preferably by coextrusion of all the layers.

Preferably, the uncoated film (A)/(B) is manufactured by co-extrusion or extrusion coating, using either a circular or a flat film die that allows shaping the polymer melt into a tubing or a flat film.

According to the first variant, the uncoated film (A)/(B) is co-extruded through a round die to obtain a tubing of molten polymer which is quenched immediately after extrusion without being expanded, optionally cross-linked, and then cooled.

In case of oriented uncoated film (A)/(B), the quenched tubing is then heated to a temperature which is above the Tg of all the resins employed and below the melting temperature of at least one of the resins employed, typically by passing it through a hot water bath or heating it with an IR oven or with hot air. The heated tubing is then stretched, still at this temperature, by internal air pressure to get the transversal orientation and longitudinally by a differential speed of the pinch rolls which hold the thus obtained “trapped bubble”.

In some instances it may be desirable to submit the oriented uncoated film (A)/(B) to a controlled heating-cooling treatment (so-called annealing) that is aimed at having a better control on low temperature dimensional stability of the uncoated (A)/(B) heat-shrinkable film.

Otherwise, the uncoated film (A)/(B) may be obtained by flat coextrusion through a slot die, followed by optional cross-linking and/or orientation by heating the flat tape to its softening temperature but below its melt temperature and stretching in the solid state on a simultaneous or a sequential tenterframe. The uncoated film (A)/(B) may be annealed, then rapidly cooled to somehow freeze the molecules of the film in their oriented state and wound.

Preferably, the uncoated film (A)/(B) is not cross-linked to preserve the good seal performance.

In case of oriented uncoated film (A)/(B), typical solid state orientation ratios for the films of the present invention can be from 2:1 to 6:1 in each direction (MD and TD), or from 3:1 to 5:1 in each direction, or from 3.5:1 to 4.5:1 in each direction.

The uncoated film (A)/(B) comprises microparticles in the base layer (B).

The microparticles may be compounded with a carrier resin, such as a polyethylene, in a e.g. twin screw extruder to give a masterbatch which is then coextruded with the raw materials for forming the thermoplastic resin layer(s) i.e. layer (b) or layer (2) with possible further inner layers, as previously defined.

Alternatively, the microparticles may be dry blended with the respective resins directly in coextrusion, without previous compounding.

The heat-sealable surface of thermoplastic uncoated film (A)/(B) is rough for the incorporation of the microparticles in the base layer (B) during coextrusion.

The Applicant found out that the rough heat-sealable surface of thermoplastic uncoated film (A)/(B) with microparticles in the base layer (B) can still efficiently entrap and immobilize the coating components, resulting in a highly hydrophobic material that is stable, namely that preserves the super-hydrophobicity over time.

Optionally, the heat-sealable surface of the thermoplastic uncoated film (A)/(B) may be further subjected to other roughening treatments such as for instance embossing, nanoimprint lithography and the like.

The process for the manufacture of the film of the invention comprises coating the surface of the heat-sealable layer (A) not directly adhered to the base layer (B) of the thermoplastic uncoated film (A)/(B) by applying an inorganic coating composition comprising hydrophobic oxide nanoparticles having an average particle diameter from 3 to 100 nm (step ii).

The coating of said surface of the heat-sealable layer (A) may be performed by any standard coating method, such as for instance by gravure coating, smooth roll coating, direct gravure, reverse gravure, offset gravure, spray coating or dip coating. As an alternative, the coating may be applied by vacuum deposition.

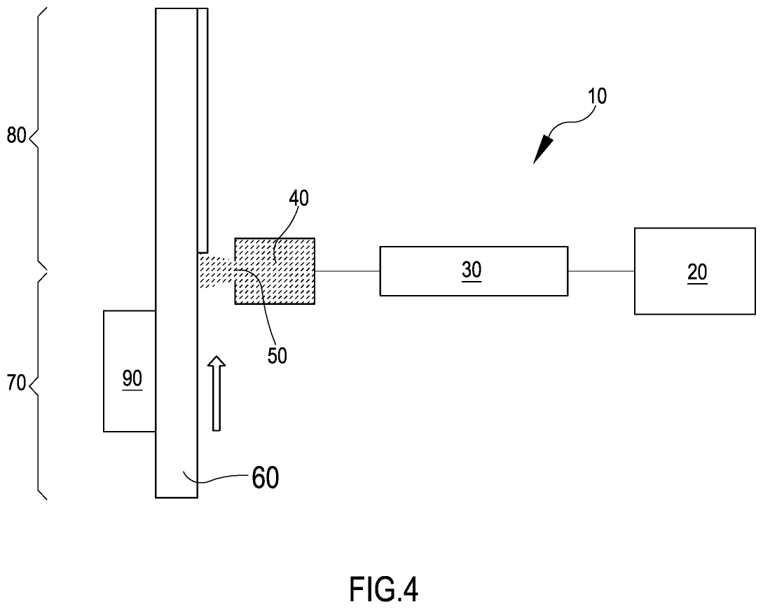

FIG. 4 is a block diagram of a process for applying a thin layer of a coating to a film by vacuum deposition according to certain embodiments of the invention.

The vacuum deposition apparatus 10 of FIG. 4 includes a Degas vessel 20 for holding the liquid coating to be applied to a film 60. The liquid coating is conveyed from the Degas vessel 20 to an evaporation chamber 30 where the liquid coating is flash evaporated to above its boiling point. The vapor is then directed from the evaporation chamber 30 to a deposition apparatus 40. The deposition apparatus 40 includes a deposition nozzle 50 for applying the coating to a surface of the film 60 under vacuum. The film 60 has an uncoated region 70 and a coated region 80 formed on the film 60 after the vacuum deposition has occurred at the deposition nozzle 50. The uncoated film 70 may pass over a cold roll 90 before or during the vapor deposition to facilitate the deposition of the coating.

The film 60 used in this coating is the uncoated thermoplastic film (A)/(B) described above, having a heat-sealable surface with indentations due to the microparticles incorporated in the base layer (B).

Flash evaporation of the liquid may occur in the evaporation chamber 30. In flash evaporation, the liquid is introduced into a heated chamber 30 under an elevated temperature, which causes the liquid to evaporate instantly. The deposition rate and the coating thickness can be accurately controlled by the rate at which the liquid is fed into the evaporation chamber.

The film to be coated 60 is handled by a conventional roll-to-roll process where the film is unwound from a pay-out reel and rewound into a roll after the coating process. In case the uncoated thermoplastic film (A)/(B) is a tubing, with the heat-sealable layer (A) as the innermost layer, preferred methods for coating said innermost surface are spray coating or wet-socking.

The amount of the coating composition applied to the heat-sealable surface of uncoated thermoplastic film (A)/(B) generally ranges from 4 to 50 g/m² (wet grammage).

The coating compositions suitable to impart super-hydrophobic properties to the uncoated thermoplastic film (A)/(B) generally are liquid dispersions, which upon deposition and subsequent drying, forms a nano-structured super-hydrophobic layer (C).

Preferably, the coating composition is a dispersion of one or more of the hydrophobic oxides previously mentioned, more preferably a dispersion of silica, alumina, titania, optionally made hydrophobic by reaction with silane coupling agents, or their admixtures.

Preferably, the coating composition further comprises other inorganic elements such as zinc or magnesium.

The coating composition preferably does not include organic film forming polymers or curable polymers.

The solvent of the coating composition may be water or an organic solvent such as alcohol, cyclohexane, toluene, acetone, ethyl acetate, propylene glycol, hexylene glycol, butyl diglycol, pentamethylene glycol, normal pentane, normal hexane, hexyl alcohol or the like

Preferably, the solvent of the coating composition is water, an alcohol or admixture thereof, more preferably, water, iso-propanol, ethanol, methanol or their admixtures. Additives such as dispersant, colorant, antisettling agent, viscosity adjuster or the like can also be included.

The amount of the hydrophobic oxide(s) in the coating composition generally ranges from about 10 to 100 g/I.

Preferably, the coating of the surface of the heat-sealable layer (A) (step ii) is carried out by applying an inorganic coating composition with a content of hydrophobic oxide(s) from 10 to 100 g/I.

Preferably, the coating of the surface of the heat-sealable layer (A) (step ii) is carried out by applying an inorganic coating composition in an amount of 4 to 50 g/m². Preferably, the coating of the surface of the heat-sealable layer (A) (step ii) is carried out by applying an inorganic coating composition with a content of hydrophobic oxide(s) from 10 to 100 g/I and in an amount of 4 to 50 g/m².

After coating deposition, the coated film is dried (step iii) by air evaporation or preferably by passing it into a hot air oven or in other conventional ovens (e.g. IR heated ovens), typically set at temperatures lower than 150° C., preferably from 80 to 120° C.

The resulting dried coating layer (C) generally has a thickness from 0.1 to 5.0 microns, preferably from 0.2 to 4.0 microns, more preferably from 1.0 to 2.0 microns. In certain embodiments of the invention, the roughened surface may be subjected to more than one coating deposition. In these embodiments, coatings comprising the same or different super-hydrophobic compounds may be deposited sequentially. A third object of the present invention is an article for packaging, preferably for food packaging.

The present article for packaging has at least an opening for introducing a product. The article for packaging may be a seamless tubing or a flexible container such as a pouch or a bag, having at least an opening for introducing a product, made from the film according to the invention.

In the article for packaging according to the present invention, the coating layer (C) is the innermost layer of the article.

Conventional manufacturing processes can be used to make the article for packaging according to the present invention.

The article for packaging is in the form of a seamless tubing or of a flexible container made from the film according to the invention, wherein the innermost surface of the tubing or of the container (i.e. the food contact surface) is the coated super-hydrophobic surface according to the invention.

The article for packaging according to the invention is a seamless tubing or a flexible container, wherein the inorganic coating layer (C) is the innermost layer of the article.

In one embodiment, the seamless tubing or the flexible container having the super-hydrophobic surface as the innermost surface, is biaxially oriented and heat shrinkable. Advantageously, the seamless tubing or the flexible container provide for packages that, when vacuumized and heat shrunk around the product, prevent the exit of juices from the packaged product.

In one embodiment, the article for packaging is in the form of a seamless tubing or of a flexible container made from a heat-shrinkable film according to the invention, wherein both the innermost and the outermost surfaces of the tubing or of the container are super-hydrophobic surfaces. This film may have the sequence of layers (C)/(A)/(B)/(C), in which the coating layers (C) may be the same or different. Advantageously, these seamless tubing or flexible container provide for bags and pouches that, when heat shrunk around the product prevent the exit of juices from the packaged product and, at the same time, do not require any drying step after shrinking in a hot water bath.

In one embodiment, the article for packaging is a seamless tubing having the super-hydrophobic surface as the innermost surface of the tubing.

The seamless tubing may be manufactured by coextrusion or extrusion coating through a round die of the layers of the present films as previously defined, optionally followed by irradiation and/or trapped bubble orientation and, possibly, annealing, as described above.

The resulting seamless tubing can be directly processed to furnish flexible packaging containers or, in alternative, can be converted to a flat film by slitting before being winded into rolls or being further re-processed

In one embodiment, the flexible container according to the present invention is a pouch.

Preferably, the thickness of the film in a pouch according to the present invention is from 50 to 150 microns.

In one embodiment, the pouch is not heat-shrinkable.

In one embodiment, the pouch is gas-barrier and not heat-shrinkable.

In one embodiment, the pouch is heat-shrinkable.

In one embodiment, the pouch is heat-shrinkable and gas-barrier.

The pouch according to the invention may be manufactured by folding, self-sealing and severing a film according to the invention.

The heat-sealing of the film to itself according to the present invention may be accomplished in a fin-seal and/or lap-seal mode.

In the fin-seal mode, two outer coated heat-sealable surfaces are faced and sealed together (i.e. a first outer coated heat-sealable surface faces another first outer coated heat-sealable surface).

In the lap-seal mode, the first outer coated heat-sealable surface is sealed onto the second outer surface of the film (i.e. the outer coated heat-sealable surface of the film overlaps the second outer surface of the film).

The pouch according to the invention may comprise two or three seals and an opening to insert the product.

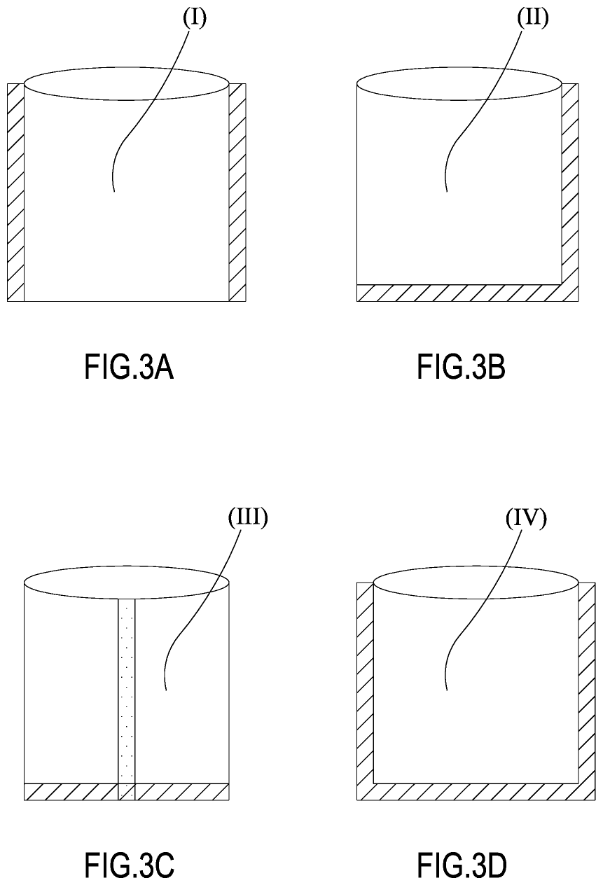

FIG. 3A-3D illustrate a few embodiments of the present pouches.

In one embodiment (I), the pouch comprises a top opening, two fin-sealed sides and a folded bottom (FIG. 3A).

In one embodiment (II), the pouch comprises a top opening, one folded side, one fin-sealed side and a fin-sealed bottom (FIG. 3B).

In one embodiment (III), the pouch comprises a top opening, two folded sides, one central longitudinal lap-seal and a fin-sealed bottom (FIG. 3C).

In one embodiment (IV), the pouch comprises a top opening, two fin-sealed sides and a fin-sealed bottom (FIG. 3D).

The pouch according to the invention may be manufactured starting from a film (embodiments I-III) or from two coupled films (embodiment IV) unwounded from a roll or, in case of two films, possibly from two separated rolls, according to known methods.

Otherwise, the pouch according to the invention may be manufactured starting from one (embodiments I-III) or two (embodiment IV) pre-cut pieces of the film of the invention, according to known methods.

The pouch according to the invention may be a pre-made pouch manufactured by conventional folding, sealing and cutting operations of the starting film(s) or of the starting pre-cut piece(s) of film, as known in the art.

Preferably, the pouch according to the invention may be manufactured, directly filled in with the product and closed in-line, according to known form-fill-seal methods, preferably by vertical form-fill-seal (VFFS) methods, thus providing the final package.

The VFFS process is known to those of skilled in the art and it is particularly used in liquid packaging. A VFFS process is described for instance in U.S. Pat. No. 4,589,247.

In brief, a flowable product is introduced through a central, vertical fill tubing to a formed tubular film having been sealed transversely, at its lower end, and longitudinally. The pouch is then completed by sealing the upper end of the tubular segment and, finally, by severing the pouch from the tubular film above it.

In one embodiment, the flexible container according to the present invention is a bag.

Preferably, the thickness of the film in a bag according to the present invention is from 35 to 90 microns.

In one embodiment, the bag is not heat-shrinkable.

In one embodiment, the bag is gas-barrier and not heat-shrinkable.

In one embodiment, the bag is heat-shrinkable.

In one embodiment, the bag is gas-barrier and heat-shrinkable.

The bag according to the invention may be manufactured by folding, self-sealing and severing a film according to the invention.

The heat-sealing of the film to itself according to the present invention may be accomplished in a fin-seal and/or lap-seal mode as previously explained.

The bag according to the present invention may be for instance an end-seal bag (ES), a, side-seal bag, a L-seal bags or a U-seal bag.

In one embodiment, the bag is an end-seal bag made from a seamless tubing, the end-seal bag having an open top, first and second folded side edges, and an end seal across a bottom of the bag.

In one embodiment, the bag is a side-seal bag having an open top, a folded bottom edge, and first and second side seals.

Other bag and pouch making methods known in the art may be readily adapted to make flexible containers from the film according to the present invention.

A fourth object of the present invention is a hermetic package comprising the film of the first object and a product, wherein the film hermetically encloses the product and wherein the surface of the package in contact with the product is the inorganic coating layer (C) of the film.

In one embodiment, the package comprises the article for packaging according to the invention hermetically enclosing a product, wherein the surface of the article for packaging in contact with the product is the super-hydrophobic coating layer (C) and the product is a food product.

In one embodiment of the present package, the article for packaging is a pouch, preferably a non-shrinkable pouch, more preferably a non-shrinkable gas-barrier pouch.

As mentioned above, a common method of packaging food and non-food products is by means of pouches made on form-fill-seal machines, such as a Horizontal Form-Fill-Seal (HFFS) or a Vertical Form-Fill Seal (VFFS) machine. During the VFFS process, the flowable product is introduced through a central, vertical fill tube into the formed tubular film, which has been sealed transversely at its lower end and longitudinally.

The flowable product may be introduced in the formed tube by gravity or, preferably, if highly viscous, may be pumped.

If not thermal sensitive, the product may be heated before being introduced into the forming pouch in order to improve its flowability or because of sterilization or pasteurization heat treatments. For example, tomato paste and sauce are generally heated at 80-85° C. before packaging.

In one embodiment of the present package, the article for packaging is a bag, preferably a shrinkable bag, more preferably a shrinkable gas-barrier bag.

Preferably, the present package is under vacuum.

When the article for packaging is a bag, in a conventional packaging process the product will be loaded into the optionally heat-shrinkable bag made of the film of the invention, the bag will normally be evacuated, and the open end thereof will be closed by heat-sealing or by applying a clip, e.g. of metal. This process is advantageously carried out within a vacuum chamber where the evacuation and application of the clip or heat seal is done automatically. After the bag is removed from the chamber it is optionally heat shrunk by applying heat. Shrinking may be done, for instance, by immersing the filled bag into a hot water bath or conveying it through a hot water shower or a hot air tunnel, or by infrared radiation. The heat treatment will produce a tight wrapping that will closely conform to the contour of the product therein packaged.

A heat shrinkable, preferably gas barrier bag from a film of the invention has wide applications, preferably for food packaging, particularly for meat, poultry, cheese, processed and smoked meat, pork and Iamb. The shrink properties of the film will in fact guarantee a complete shrinkage of the bag around the product, so that the bag is not wrinkled, thus offering an attractive package also reducing the drip loss. The bag will have proper abuse resistance in order to physically survive the process of being filled, evacuated, sealed, closed, heat shrunk, boxed, shipped, unloaded, and stored at the retail supermarket, and a sufficient stiffness to improve also its loading process.

In one embodiment, the present package comprises a drip-releasing food product such as for instance fresh meat or processed meat.

Preferably, drip-releasing food products are packaged in vacuumized gas barrier shrinkable bags according to the invention.

In one embodiment, the package is vacuumized and shrunk and the product is fresh meat.

In one embodiment, the package comprises a highly viscous or sticky product, preferably a highly viscous or sticky food product.

Examples of highly viscous or sticky food products are tomato sauce, tomato paste concentrate, hazelnut spread, sauces, condiments, soups, jams, marmalades, caramel sauce, chocolate sauces, icing for cake decorations and peanut butter.

Preferably, highly viscous or sticky food products are packaged in non-shrinkable gas barrier pouches according to the invention.

The package optionally comprises at least one tear initiator.

A fifth object of the present invention is the use of the film of the first object for packaging a product, preferably for packaging a highly viscous, sticky or drip-releasing product, wherein the surface of the package in contact with the product is the inorganic coating layer (C) of the film. Preferably, the product is a food product. The present invention is further illustrated by the following Examples.

### EXAMPLES

The following resins were used in the manufacture of the films:

TABLE 1

| Tradename | Supplier | Acronym |
|---|---|---|
| EXCEED 4518PA | ExxonMobil | LLDPE1 |
| Surpass FPs417-A | NOVA Chemicals | LLDPE2 |
| EXCEED 1012MA | ExxonMobil | LLDPE3 |
| 10,075ACP Syloid Concentrate | Teknor Color | LDPE1 |
| LD-102.74 | ExxonMobil | LDPE2 |
| ELVAX 3165 | DuPont | EVA1 |
| BYNEL 4125 | DuPont | LLDPE-md1 |
| GT4408 | Westlake Chemicals | LLDPE-md2 |
| Aegis H155ZP | AdvanSix | PA-6 |
| E171B | EVALCA/Kuraray | EVOH/EVAL1 |
| Eval H171B | EVALCA/Kuraray | EVOH/EVAL2 |
| T60-500-119 | Ineos | HDPE |
| Spheriglass 3000 | Potters Industries | Glass |
| | | microparticles |

wherein
LLDPE1: Density 0.9180 g/cc, Melt Flow Rate (190° C./2.16 kg) 4.50 g/10 min, Melting point 114.0° C.
LLDPE2: Density 0.917 g/cc, Melt Flow Rate (190° C./2.16 kg) 4.50 g/10 min
LLDPE3: Density 0.912 g/cc, Melt Flow Rate (190° C./2.16 kg) 1.00 g/10 min
LDPE1: Antiblock resin, Ash 9.2%, Density 0.97 g/cc, Melt Flow Rate (190° C./2.16 kg) 3.00 g/10 min, Moisture Content Max 0.20% LDPE2: antiblock resin Ash 2.40%, Density 0.92 g/cc, Melt Flow Rate (190° C./2.16 kg) 6.5 g/10 min, Melting point 110° C.
EVA1: Comonomer content (Vinyl Acetate) 18%, Density 0.940 g/cc, Melt Flow Rate (190° C./2.16 kg)·0.70 g/10 min, Melting point 87.0° C., Moisture Content Max 0.3%, Vicat softening point 69.0° C.
LLDPE-md1: Comonomer content (Maleic Anhydride) Min 0.09 Max 0.15%, Density 0.930 g/cc, Melt Flow Rate (190° C./02.16 kg). 2.50 g/10 min, Melting point 126.0° C., Vicat softening point 109° C.
LLDPE-md2: Density 0.919 g/cc, Melt Flow Rate (190° C./02.16 kg). 2.3 g/10 min, Melting point 122.0° C.
PA-6: Density 1.130 g/cc, Melting point 220° C., Viscosity relative 155
EVOH/EVAL1: Comonomer content 44%, Crystallization point 144° C., Density 1.14 g/cc, Glass Transition 54° C., Melt Flow Rate (190° C./02.16 kg) 1.7 g/10 min, Melting point 165° C., Vicat softening point 152° C.,
EVOH/EVAL2: Comonomer content 38%, Crystallization point 148° C., Density 1.17 g/cc, Glass Transition 53° C., Melt Flow Rate (190° C./02.16 kg) 1.7 g/10 min, Melting point 172° C.
HDPE: Density 0.961 g/cc, Melt Flow Rate (190° C./02.16 kg). 6.20 g/10 min, melting point 135.0° C.
Glass microparticles: Solid glass microspheres, average particle size: 30-50 μm, Tapped bulk density: 1.59 g/cc.

### Film Structures

The following films were manufactured:

TABLE 2
multilayer films

| | Comparative | Comparative | |
|---|---|---|---|
| | film C1 | film C2 | Ex. 1 |
| | (no coating, | (no coating, | (coating, |
| | no | microparticles | microparticles |
| Layer | microparticles) | in layer 2) | in layer 2) |
| 0 Coating | — | — | Super- |
| (C) | | | hydrophobic |
| | | | coating |
| 1 Heat- | LLDPE1 95% | LLDPE1 95% | LLDPE1 95% |
| sealable | LDPE1 5% | LDPE1 5% | LDPE1 5% |
| (A) | (15 mic) | (15 mic) | (15 mic) |
| 2 | EVA1 100% | LLDPE1 75% | LLDPE1 75% |
| | (15 mic) | Glass micro- | Glass micro- |
| | | particles 25% | particles 25% |
| | | (15 mic) | (15 mic) |
| 3 | EVA1 100% | EVA1 100% | EVA1 100% |
| | (7 mic) | (7 mic) | (7 mic) |
| 4 | LLDPE- | LLDPE- | LLDPE- |
| | md1 100% | md1 100% | md1 100% |
| | (10 mic) | (10 mic) | (10 mic) |
| 5 | EVOH/ | EVOH/ | EVOH/ |
| | EVAL1 100% | EVAL1 100% | EVAL1 100% |
| | (12 mic) | (12 mic) | (12 mic) |
| 6 | LLDPE- | LLDPE- | LLDPE- |
| | md1 100% | md1 100% | md1 100% |
| | (10 mic) | (10 mic) | (10 mic) |
| 7 | EVA1 100% | EVA1100% | EVA1 100% |
| | (22 mic) | (22 mic) | (22 mic) |
| 8 Outer | HDPE 95% | HDPE 95% | HDPE 95% |
| | LDPE1 5% | LDPE1 5% | LDPE1 5% |
| | (9 mic) | (9 mic) | (9 mic) |
| Total | 100 mic. | 100 mic | 100 mic |
| Thickness | | | |

| | Comparative | Comparative |
|---|---|---|
| | film C3 | film C4* |
| | (no coating, | (coating, |
| | microparticles | microparticles |
| Layer | in layer 1) | in layer 1) |
| 0 Coating | — | Super-hydrophobic |
| (C) | | coating |
| 1 Heat- | LLDPE1 75% | LLDPE1 75% |
| sealable | Glass | Glass |
| (A) | microparticles 25% | microparticles 25% |
| | (15 mic) | (15 mic) |
| 2 | EVA1 100% | EVA1 100% |
| | (15 mic) | (15 mic) |
| 3 | EVA1 100% | EVA1 100% |
| | (7 mic) | (7 mic) |
| 4 | LLDPE-md1 100% | LLDPE-md1 100% |
| | (10 mic) | (10 mic) |
| 5 | EVOH/EVAL1 100% | EVOH/EVAL1 100% |
| | (12 mic) | (12 mic) |
| 6 | LLDPE-md1 100% | LLDPE-md1 100% |
| | (10 mic) | (10 mic) |
| 7 | EVA1100% | EVA1100% |
| | (22 mic) | (22 mic) |
| 8 | HDPE 95% | HDPE 95% |
| | LDPE1 5% | LDPE1 5% |
| | (9 mic) | (9 mic) |
| Total | 100 mic | 100 mic |
| Thickness | | |
| | | Comparative |
| | Ex. 2 | film C5 |
| | (coating, | (coating, |
| | microparticles | microparticles |
| Layer | in layer 2) | in layer 1) |
| 0 Coating | Super-hydrophobic | Super-hydrophobic |
| (C) | coating | coating |
| 1 Heat- | LLDPE2 70% | LLDPE1 75% |
| sealable | LDPE2 30% | Glass |
| (A) | (9.8 mic) | microparticles 25% |
| | | (9.8 mic) |
| 2 | LLDPE3 70% | LLDPE2 70% |
| | Glass | LDPE2 30% |
| | microparticles 25% | (14 mic) |
| | (14 mic) | |
| 3 | LLDPE-md2 100% | LLDPE-md2 100% |
| | (9.8 mic) | (9.8 mic) |
| 4 | PA-6 100% | PA-6 100% |
| | (18.2 mic) | (18.2 mic) |
| 5 | EVOH/EVAL2 100% | EVOH/EVAL2 100% |
| | (14 mic) | (14 mic) |
| 6 | PA-6 100% | PA-6 100% |
| | (18.2 mic) | (18.2 mic) |
| 7 | LLDPE-md2 100% | LLDPE-md2 100% |
| | (9.8 mic) | (9.8 mic) |
| 8 | LLDPE2 70% | LLDPE2 70% |
| | LDPE2 30% | LDPE2 30% |
| | (39.1 mic) | (39.1 mic) |
| 9 | LLDPE2 70% | LLDPE2 70% |
| | LDPE2 30% | LDPE2 30% |
| | (7 mic) | (7 mic) |
| Total | 139.9 mic | 139.9 mic |
| Thickness | | |

C4*: film according to the teaching of EP2397319B1

The comparative film C1 represents a conventional film, not comprising microparticles and non-coated. It was manufactured on a downward round cast line. The eight layers were coextruded in their respective extruders, and coextruded in a round coextrusion die. At the die exit, the melt was drawn downwards by a couple of nip rolls, followed by quenching on the outside surface with a water cascade. After the nip rolls, which collapsed the tubing in a flat “tape” form, the quenched tape was collected on a winder. This double tape was finally edge ripped, separated into two single films and slit to the desired width.

The comparative films C2 and C3 were prepared in a manner similar to C1, but, at extrusion, glass microparticles were incorporated in the layer indicated in Table 2, respectively, in order to impart surface roughness.

The uncoated films C2 and C3 were then coated by applying an inorganic hydrophobic coating composition thus obtaining, after drying, the corresponding coated film of the invention of Ex. 1 and coated comparative film C4, respectively. The inorganic hydrophobic coating composition was prepared by dispersing 5 g of hydrophobic oxide nanoparticles (Aerosil R812S (Evonik Degussa), BET specific surface area 220 m²/g, average primary particle diameter 7 nm) in 100 ml ethanol. The hydrophobic coating composition was applied by a standard gravure coating process on a conventional equipment. Process application and drying conditions were: machine speed: 120 m/min; coating roll: gravure roll, having 50 lines/cm; coating composition weight: about 15 g/m² (wet grammage), oven drying temperature: 90° C. The final coating was about 0.5 microns thick, with a dry weight of about 0.3 g/m².

The film of Ex. 2 and the comparative film C5 are high abuse resistant films, comprising two polyamide layers. Both films were prepared by coextrusion as described above, incorporating glass microparticles in the layer indicated in Table 2, (i.e, in layer 2 for the film of Ex. 1 and in layer 1 for C5), in order to impart surface roughness. After coextrusion, the inorganic hydrophobic coating composition described above was applied by a standard gravure coating process on a conventional equipment, in the same conditions as described above. Layer C of Ex. 2 and of the comparative film C5 is the same as layer C of Ex. 1.

### Film Properties

The comparative films and the film of the invention were characterized according to the following tests.

### Water Contact Angle

The static water contact angle of the above films was measured according to ASTM D7490-13.

Contact angles were measured for comparative films C1, C2, C4 and for the film of the invention of Ex. 1. Contact angles were measured on the outermost surface corresponding to layer (1), which is uncoated in C1 and C2 and coated with the super-hydrophobic coating in Example 1 and C4.

The results are collected in the following Table 3:

TABLE 3

| | Roughened | | Water contact |
|---|---|---|---|
| Film | surface | Coating | angle (°) |
| C1 | No | No | 81.4 |
| C2 | Yes | No | 72.6 |
| Ex. 1 | Yes | Yes | >160° |
| C4 | Yes | Yes | >160° |

As can be seen, the water contact angle of the comparative uncoated film C1 was 81.4° while a lower value of 72.6° was measured for the comparative uncoated film that incorporated microparticles in layer (2) (C2). These values are typical of hydrophilic wettable surfaces.

On the contrary, the coated surfaces of the comparative film C4 and of the film of the invention of Ex. 1 show very high contact angles in line with the low wettability shown by this surfaces.

The contact angle of the film of Ex. 1 was measured again after 6 months of storage (film wound in a roll kept at 23° C. and 50% relative humidity) without observing any significant change (contact angle still about 160°). From this data, it follows that the film of the invention was able to keep the superhydrophobicity overtime.

These super-hydrophobic surfaces, when in contact with the product in the final package, are responsible for the high evacuation yield (low adhesion to the product) and unexpected drip loss prevention.

### Machinability

Mill logs of the coated film of Ex. 2 (according to the invention) and the coated film C5 were slit into 510 mm wide rolls on a Dusenbery slitter. The slit rolls were visually inspected and their quality resulted good in terms of planarity and edge profile. The slit rolls were then tested on an Onpack 2070 equipment to check their machinability: both coated films ran well.

The presence of the hydrophobic coating therefore does not affect negatively the machinability of the films.

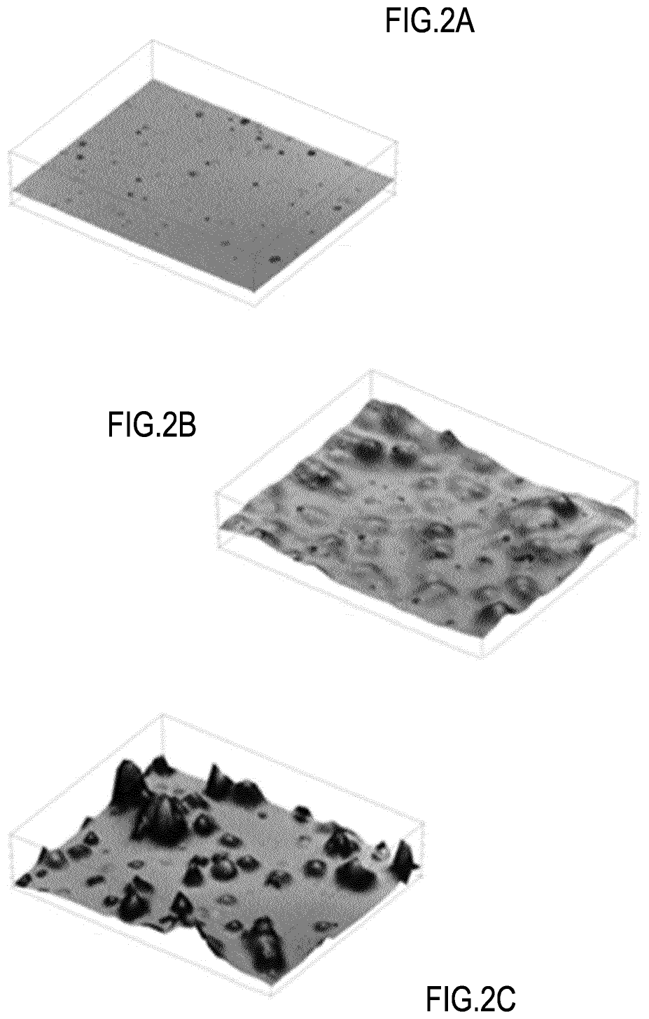

### Microscope Analysis (FIG. 2A-2C)

Three specimens of the films C1, C2 and C3 spaced around each tubing sample were cut and mounted to a glass slide with double-stick adhesive tape. C2 corresponds to the film of Ex. 1 without the hydrophobic coating. C3 corresponds to the C4 film without the hydrophobic coating. From each specimen, two random locations were imaged with white-light confocal microscopy (magnification of the microscope objective lens 20×), and the resulting height maps were filtered (noise cut followed by median) and leveled. Standard, two-dimensional roughness statistics were calculated based on 32 equally spaced, horizontal cross-sections. Three-dimensional images were created by superimposing the visible image over the height map.

### Film Surface Roughness

As illustrated in FIG. 2B, the roughened surface of the uncoated C2 film, which is part of the film of the invention of Ex. 1, is characterized by a Mean Roughness (Roughness Average Ra) of about 0.29 μm, by a Root Mean Square (RMS) roughness (Rq) of about 0.34 μm and by a Mean Roughness Depth (Rz) of about 1.81 μm, measured according to ISO4287.

Conventional film C1, illustrated in FIG. 2A, that does not comprise microparticles, typically shows lower values of roughness such as Ra of about 0.019 μm, Rq of about 0.022 μm and Rz of about 0.126 μm.

The roughness of the uncoated C3 film, which is part of the comparative film C4—which comprises microparticles in the heat-sealable layer (A) as the films described in EP2397319B1—is illustrated in FIG. 2C. This film shows higher values of roughness, in particular Ra of about 0.49 μm, Rq of about 0.58 μm and Rz of about 3.48 μm.

Roughness was measured also for the coated films of Ex. 2 and C5. The roughened surface of the coated film of Ex. 2 is characterized by a Mean Roughness (Roughness Average Ra) of about 0.35 μm, by a Root Mean Square (RMS) roughness (Rq) of about 0.42 μm and by a Mean Roughness Depth (Rz) of about 2.96 μm, measured according to ISO4287.

Coated film C5, with microparticles in the heat-sealable layer (A) has greater roughness values, namely a Mean Roughness (Roughness Average Ra) of about 0.54 μm, a Root Mean Square (RMS) roughness (Rq) of about 0.65 μm and a Mean Roughness Depth (Rz) of about 4.48 μm, measured according to ISO4287.

### Packaging: Food Evacuation Test

The comparative films C1, C4 and the film according to the invention of Ex. 1 were used to manually manufacture pouches (250×460 mm) using the laboratory Gandus TS Impulse Sealer.

In the final packages, the heat sealable surface was the internal surface of the pouch, directly contacting the packaged products.

Three pouches for each film were manually filled with approximately 3000 g of each of the products listed below and weighted.

The filled pouches were sealed (sealing temperature: 170° C., sealing time: 1.5 sec) and stored at room temperature for 3 days. After 3 days, the pouches were evacuated and the empty pouches were weighted again.

The weight difference (grams) corresponds to the amount of product retrieved from the package: this weight difference was converted in percentage to obtain the percentage evacuation yield.

The food products used in the evacuation tests were: tomato sauce (from “La Fiammante”), tomato paste (from “Horeca”), mayonnaise (from “Algea”) and caramel sauce (from “Horeca”).

The detailed results of the evacuation test for caramel sauce are collected in the following Table 4:

TABLE 4
(weights in grams)

| | Filled | | Product | Evacuated | | Evacuation |
|---|---|---|---|---|---|---|
| | pouch | Pouch | net | product | Evacuation | yield (%) |
| Film | weight | weight | weight | weight | yield (%) | (average) |
| C1 | 2930 | 25 | 2905 | 2725 | 93.8 | 94.2 |
| | 3020 | | 2995 | 2815 | 94.0 | |
| | 2980 | | 2955 | 2800 | 94.8 | |
| Ex 1 | 2980 | 25 | 2955 | 2950 | 99.8 | 99.5 |
| | 2995 | | 2970 | 2955 | 99.5 | |
| | 3010 | | 2985 | 2965 | 99.3 | |
| C4 | 3030 | 25 | 3005 | 3005 | 100.0 | 99.7 |
| | 2975 | | 2950 | 2945 | 99.8 | |
| | 3010 | | 2985 | 2960 | 99.2 | |

The data in the table above demonstrate that pouches made with the film of the invention, with the super-hydrophobic coated surface as the inner surface of the pouches, i.e. in direct contact with the product, can be evacuated with higher yields than the comparative, uncoated C1 film. The evacuation yield for the pouches made with the film of the invention are very close to 100% for caramel sauce. In addition, no significant difference in terms of evacuation yield is observed between Ex. 1 (glass microparticles incorporated in layer 2) and C4 (glass microparticles incorporated in layer 1).

The evacuation test was performed also for coated films Ex. 2 (glass microparticles incorporated in layer 2) and C5 (glass microparticles incorporated in layer 1) with results comparable and in line with the evacuation yields obtained for the coated films of Ex. 1 and C4.

A summary of the results of the evacuation test for the other products (tomato sauce, tomato paste and mayonnaise) are collected in the following Table 5:

TABLE 5

| | Evacuation yield (%) (average) | | |
|---|---|---|---|
| Product | C1 | Ex. 1 | C4 |
| Tomato sauce | 97 | 99 | 99 |
| Tomato paste | 95 | 98 | 98 |
| Mayonnaise | 96 | 99 | 99 |

The evacuation yield values presented in Table 5 are the average values over three repeated tests.

As shown in Tables 4 and 5, pouches made with the film of the invention can be evacuated with higher evacuation yields than pouches made with the comparative, uncoated film. Further to caramel, also for tomato sauce, tomato paste and mayonnaise the yields are close to 100%. Such high evacuation yields mean that a greater amount of product can be recovered, with an economic saving and a reduction of food waste.

### Opening Force (Seal Strength)

For the evaluation of the force required to open a finished package made with the film of the invention, the following internal standard procedure was used.

Specimens having dimensions of 2.54 cm (1 inch) of width and about 15-20 cm of length, cut along the machine direction (namely along the direction of unwinding of the roll) were obtained from pouches manually manufactured using the laboratory Gandus TS Impulse Sealer (sealing temperature 170° C., sealing time 1.5 sec). The strength of the fin seals (i.e the seals in which the coated heat-sealable surfaces faced each other and were sealed together) was evaluated for the film of the invention of Ex. 1 and for the comparative film C4.

The sealed films were manually separated in order to provide detached film portions sufficient to be fixed into the lower jaw and into the upper jaw of a dynamometer. The area to be tested should lie in the middle of the two jaws, and an adequate tensioning between the two extremities of the fixed sample should be obtained.

Five specimens were prepared and tested for each film and the average value of the opening force was calculated.

The dynamometer conditions were:
equipment: Instron 5564
starting jaw distance: 2 cm
crosshead speed: 300 mm/min,
length of the seal opened for measure: 0.8 cm.

The instrument measured the force needed to separate the two sealed films, in particular measured the average force applied for the opening of 0.8 cm of the seal for each sample (g/inch). Finally, the average of force values for the five specimens tested was calculated and reported in the following Table 6:

TABLE 6

| | Seal strength | Seal strength |
|---|---|---|
| Film | (average force) (g/inch) | (minimum force) (g/inch) |
| Ex. 1 | 6100 | 5200 |
| C4 | 4400 | 1200 |

As can be seen from the data reported in Table 6, the seal strength of the samples prepared with the film according to the invention (Ex. 1 with microparticles in Layer 2) is much higher than that of the samples made from comparative film C4 (with microparticles in the heat-sealable layer 1).

A sealability test was also performed on finished packages made with the coated film of Ex. 2 (according to the invention) and the coated film C5. Pouches were prepared with the film of Ex. 2 and C5, filled in with an oily product (namely, Ranch dressing) and sealed, using an Onpack 2070 machine. The sealing of the pouches was visually inspected and considered good (no leaks of the fluid product were observed). The seal strength of these pouches was tested by trying to open manually the pouches, and it was evaluated as strong. Therefore, the hydrophobic coating is not detrimental for the sealing properties of the films.

### Vacuumized Bags (Drip Retention)

The comparative film C1 and the film according to the invention of Ex. 1 were used to package fresh beef cuts 250-300 g each in vacuum bags. In the final packages, the heat sealable surface of the films was the internal surface of the bag, directly contacting the packaged meat.

Five bags for each film were manufactured in a conventional packaging cycle, including vacuumization and sealing, carried out on a Cryovac VS20 machine (vacuum 5 mBar, seal time 1.5 sec, cooling time 2 sec, seal setting Ultraseal 310 (170° C.)).

The packages were kept in a refrigerator at 8° C. and checked for purge formation after 3 days and after 8 days. Under visual inspection, all the packages made from the film of Ex. 1 always showed a better appearance and a reduced presence of purge in comparison with the packages made with the comparative film C1.

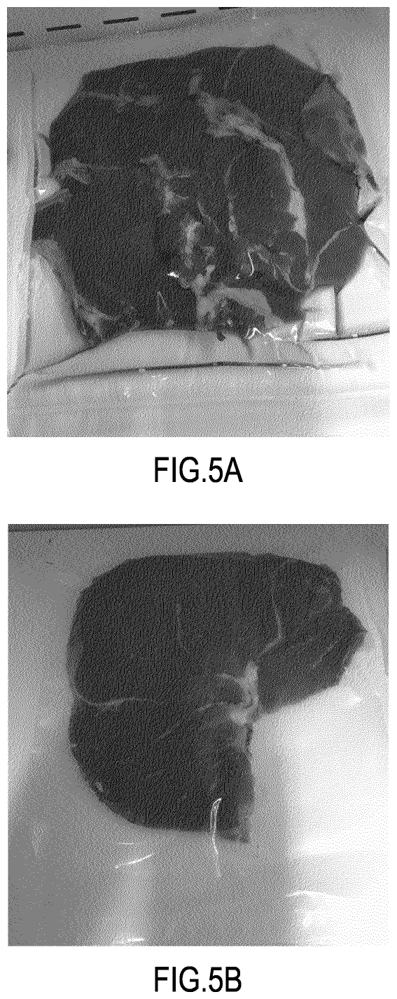

As can be seen from the pictures of FIGS. 5A and 5B, taken after 10 days, the film of the invention (Ex. 1) was effective in preventing release of juices from the packaged fresh meat (FIG. 5B). On the contrary, the non-coated comparative film C1 had little effect on drip formation and purge was clearly visible in the package (FIG. 5A).

In conclusion, the data reported above show that the film of the invention, comprising microparticles in the layer directly adhered to the heat-sealable layer (i.e. into the second layer), are better than prior art films having the microparticles in the heat sealable layer. In fact, they are characterized by a comparable contact angle but with improved sealing performances.

The improved sealability allowed manufacturing flexible packages with excellent recovery of flowable or sticky products packaged therein and with an unexpected reduction in purge formation.

1. A super-hydrophobic coated thermoplastic multilayer packaging film comprising:
a thermoplastic mono or multilayer base layer (B),
a thermoplastic heat-sealable layer (A) directly adhered to the base layer (B), and
an inorganic coating layer (C) comprising hydrophobic oxide nanoparticles directly adhered to the surface of the heat-sealable layer (A) not directly adhered to the base layer (B),
wherein said hydrophobic oxide nanoparticles of layer (C) have an average particle diameter from 3 to 100 nm and are present in amount from 0.01 to 10 g/m² (grammage after drying), characterized in that
the base layer (B) comprises microparticles having an average particle diameter from 0.5 to 100 microns in amount of at least 1% calculated in respect of the total weight of the layer(s) in which the microparticles are incorporated.

2. The film according to claim 1 wherein the heat-sealable layer (A) comprises less than 1% microparticles calculated in respect of layer (A) weight having an average particle diameter higher than 0.5 microns.

3. The film according to claim 1 wherein the heat-sealable layer (A) of the present film comprises a major amount of a polymer selected among ethylene-vinyl acetate copolymers (EVA), homogeneous or heterogeneous, linear ethylene-alpha-olefin copolymers, polypropylene copolymers (PP), ethylene-propylene copolymers (EPC), acrylates, methacrylates, ionomers, polyesters and their blends.

4. The film according to claim 1 wherein the thermoplastic base layer (B) is monolayer (b) comprising a major proportion of one or more thermoplastic resins selected from polyethylenes, polypropylenes, ethylene vinyl acetates (EVAs), ionomers, polyamides, polyesters, optionally blended with adhesive resins.

5. The film according to claim 1 wherein the thermoplastic base layer (B) is multilayer and wherein only the layer directly adhered to the heat-sealable layer (A) comprises the microparticles.

6. The film according to claim 5 wherein the layer directly adhered to the heat-sealable layer (A) comprises a major proportion of one or more polymers selected among polyolefins and modified polyolefins.

7. (canceled)

8. The film according to claim 1 wherein the microparticles are selected among acrylic microparticles, silica microparticles, boron silicate microparticles, calcium phosphate microparticles, calcium stearate microparticles, glass microparticles and charcoal powders.

9. The film according to claim 1 wherein the content of microparticles is from 1 to 80% calculated in respect of the total weight of the layer(s) in which the microparticles are incorporated.

10. The film according to claim 1 wherein the multilayer base layer (B) comprises an inner gas barrier layer (F).

11. The film according claim 1 wherein the coating layer (C) has a thickness from 0.1 to 5.0 microns 1.0 microns.

12. The film according to claim 1 wherein hydrophobic oxide nanoparticles of the inorganic coating layer (C) have an average particle diameter from 5 to 50 nm.

13. The film according to claim 1 wherein hydrophobic oxide nanoparticles of the inorganic coating layer (C) are selected from silica, alumina, magnesia, titania and their admixtures.

14. The film according to claim 1 wherein the surface of the inorganic coating layer (C) not directly adhered to layer (A) has a water contact angle higher than 130°, measured according to ASTM D7490-13.

15. A process for the manufacture of a super-hydrophobic coated thermoplastic multilayer packaging film comprising:
a thermoplastic mono or multilayer base layer (B),
a thermoplastic heat-sealable layer (A) directly adhered to the base layer (B), and
an inorganic coating layer (C) comprising hydrophobic oxide nanoparticles directly adhered to the surface of the heat-sealable layer (A) not directly adhered to the base layer (B),
wherein said hydrophobic oxide nanoparticles of layer (C) have an average particle diameter from 3 to 100 nm and are present in amount from 0.01 to 10 g/m² (grammage after drying),
characterized in that
the base layer (B) comprises microparticles having an average particle diameter from 0.5 to 100 microns in amount of at least 1% calculated in respect of the total weight of the layer(s) in which the microparticles are incorporated, the process comprises the steps of:
i) providing a thermoplastic uncoated film (A)/(B) comprising
a thermoplastic mono or multilayer base layer (B),
an outer thermoplastic heat-sealable layer (A) directly adhered to the base layer (B),
wherein the base layer (B) comprises microparticles having an average particle diameter from 0.5 to 100 microns in amount of at least 1% calculated in respect of the total weight of the layer(s) in which the microparticles are incorporated,
ii) coating the surface of the heat-sealable layer (A) not directly adhered to the base layer (B) of the thermoplastic uncoated film (A)/(B) by applying an inorganic coating composition comprising hydrophobic oxide nanoparticles having an average particle diameter from 3 to 100 nm, and
iii) drying the applied coating thus forming an inorganic coating layer (C) comprising hydrophobic oxide nanoparticles in amount from 0.01 to 10 g/m² (grammage after drying).

16. The process according to claim 15 wherein the coating of the surface of the heat-sealable layer (A) (ii) is carried out by applying the inorganic coating composition with a content of hydrophobic oxide(s) from 10 to 100 g/l

17. The process according to claim 15 wherein the coating of the surface of the heat-sealable layer (A) (ii) is carried out by applying the inorganic coating composition in an amount of 4 to 50 g/m² (wet grammage).

18. The process according to claim 15 wherein the solvent of the coating composition is selected among water, alcohols and their admixtures.

19. An article for packaging made from a super-hydrophobic coated thermoplastic multilayer packaging film comprising:
a thermoplastic mono or multilayer base layer (B),
a thermoplastic heat-sealable layer (A) directly adhered to the base layer (B), and
an inorganic coating layer (C) comprising hydrophobic oxide nanoparticles directly adhered to the surface of the heat-sealable layer (A) not directly adhered to the base layer (B),
wherein said hydrophobic oxide nanoparticles of layer (C) have an average particle diameter from 3 to 100 nm and are present in amount from 0.01 to 10 g/m² (grammage after drying),
characterized in that
the base layer (B) comprises microparticles having an average particle diameter from 0.5 to 100 microns in amount of at least 1% calculated in respect of the total weight of the layer(s) in which the microparticles are incorporated, the article for packaging having at least an opening for introducing a product, wherein the inorganic coating layer (C) of the film is the innermost layer of the article.

20. (canceled)

21. (canceled)

22. (canceled)

23. (canceled)

24. The article for packaging according to claim 19 wherein the article for packaging is a hermetic package wherein the film hermetically encloses a product and wherein the surface of the article for packaging in contact with the product is the inorganic coating layer (C) of the film, article for packaging is vacuumized and shrunk and the product is fresh meat.

25. The article for packaging according to claim 19 wherein the article for packaging is a hermetic package wherein the film hermetically encloses a product and wherein the surface of the article for packaging in contact with the product is the inorganic coating layer (C) of the film, article for packaging is a non-shrinkable pouch and the product is a highly viscous or sticky food product.

26. (canceled)
